(19) United States
(12) Patent Application Publication
(10) Pub. No.: US 2016/0093228 A1
(43) Pub. Date: Mar. 31, 2016

(54) RECORDING MEDIUM STORING EVALUATION SUPPORT PROGRAM, EVALUATION SUPPORT METHOD, AND EVALUATION SUPPORT APPARATUS

(71) Applicant: FUJITSU LIMITED, Kawasaki-shi (JP)

(72) Inventors: Hidehiko Mayumi, Kawasaki (JP); Toshio Tanaka, Yokohama (JP); Takeaki Kobayashi, Yokohama (JP); Masahiro Kawasaki, Kawasaki (JP)

(21) Appl. No.: 14/853,665

(22) Filed: Sep. 14, 2015

(30) Foreign Application Priority Data
Sep. 30, 2014 (JP) 2014-201817

(51) Int. Cl. G09B 7/00; G09B 7/06; G09B 7/02

(52) U.S. Cl. CPC G09B 7/00; G09B 7/02; G09B 7/06

(57) ABSTRACT

A non-transitory computer-readable recording medium stores a program for causing a computer to execute a process. The process includes generating screen data for answering questions about opinion information related to a topic which is input from a first student terminal; transmitting the screen data to second student terminals; collecting answers to the questions input from the second student terminals; and calculating correct answer rates of the answers to the questions.

### CROSS-REFERENCE TO RELATED APPLICATION

This application is based upon and claims the benefit of priority of the prior Japanese Patent Application No. 2014-201817, filed on Sep. 30, 2014, the entire contents of which are incorporated herein by reference.

### FIELD

The embodiment discussed herein is related to a recording medium storing an evaluation support program, an evaluation support method, and an evaluation support apparatus.

### BACKGROUND

Recently, a demonstration test, etc., of next-generation education has been conducted in which terminal apparatuses such as tablet terminals are used. Further, it is thought that such next-generation education will become more popular across the country.

As a known class style conducted in such next-generation education, a topic is first transmitted from a terminal device of a teacher to terminal devices of students, so that the students input their opinions about the topic in their terminal devices and then the students present their opinions in the class.

Reference is made to Japanese Laid-open Patent publication Nos. 2005-352152 and 2004-191528.

### SUMMARY

According to an aspect of the present invention, a non-transitory computer-readable recording medium stores a program for causing a computer to execute a process. The process includes generating screen data for answering questions about opinion information related to a topic which is input from a first student terminal; transmitting the screen data to second student terminals; collecting answers to the questions input from the second student terminals; and calculating correct answer rates of the answers to the questions.

The objects and advantages of the embodiments disclosed herein will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 illustrates an example configuration of an evaluation support system according to a first embodiment;

FIG. 2 illustrates an example class style using the evaluation support system;

FIG. 3 illustrates an example hardware configuration of a teacher terminal;

FIG. 4 illustrates an example of a student database;

FIG. 5 illustrates an example of a topic database;

FIG. 6 illustrates an example of an opinion database;

FIG. 7 illustrates an example of a question-answer database;

FIG. 8 illustrates an example of a message database;

FIG. 9 illustrates an example of a listener message database;

FIG. 10 illustrates an example of a speaker message database;

FIG. 11 illustrates an example of a threshold value table;

FIG. 12 illustrates an example of a student level table;

FIG. 13 illustrates the functions of the teacher terminal and a student terminal;

FIG. 14 is a flowchart of the operations of the teacher terminal;

FIG. 15 is a flowchart of the operations of an opinion collection process performed in the teacher terminal;

FIG. 16 is a flowchart of the operations of a correct answer rate calculation process performed in the teacher terminal;

FIG. 17 is a flowchart of the operations of an evaluation process performed in the teacher terminal;

FIG. 18 illustrates an example of a topic selection screen displayed on the teacher terminal;

FIG. 19 illustrates an example of a topic answer screen displayed on the student terminal;

FIG. 20 illustrates another example of the topic answer screen displayed on the student terminal;

FIG. 21 illustrates an example of a matrix display screen displayed on an electronic whiteboard;

FIG. 22 illustrates an example of a speaker screen displayed on the student terminal of a speaker;

FIG. 23 illustrates an example of an listener screen displayed on the student terminal of a listener;

FIG. 24 illustrates an example of a transmission screen to transmit an evaluation question displayed on the teacher terminal;

FIG. 25 illustrates a first example of a question answer screen displayed on the student terminal of the listener;

FIG. 26 illustrates a second example of the question answer screen displayed on the student terminal of the listener;

FIG. 27 illustrates a third example of the question answer screen displayed on the student terminal of the listener;

FIG. 28 illustrates a first example of a speaker evaluation screen displayed on the student terminal of the speaker;

FIG. 29 illustrates a second example of a speaker evaluation screen displayed on the student terminal of the speaker;

FIG. 30 illustrates an example of a teacher evaluation screen displayed on the teacher terminal; and

FIG. 31 illustrates an example configuration of the evaluation support system according to a second embodiment.

### DESCRIPTION OF EMBODIMENT

In a class style of next-generation education, it is desired to improve both the ability to speak and the ability to listen of the students. To that end, it is desired for the teacher to appropriately evaluate how much of the presentation content can be presented by the student as the presenter (ability to speak/communicate) or how much of the presentation content can be listened to (understood) by the student as the audience (ability to listen (understand)), and then guide the students based on the ability of the students.

It is, however, difficult for the teacher to evaluate the “ability to speak” and the “ability to listen” of the students because the teacher teaches a class of many students.

According to an embodiment, it becomes possible to support the evaluation of students.

### First Embodiment

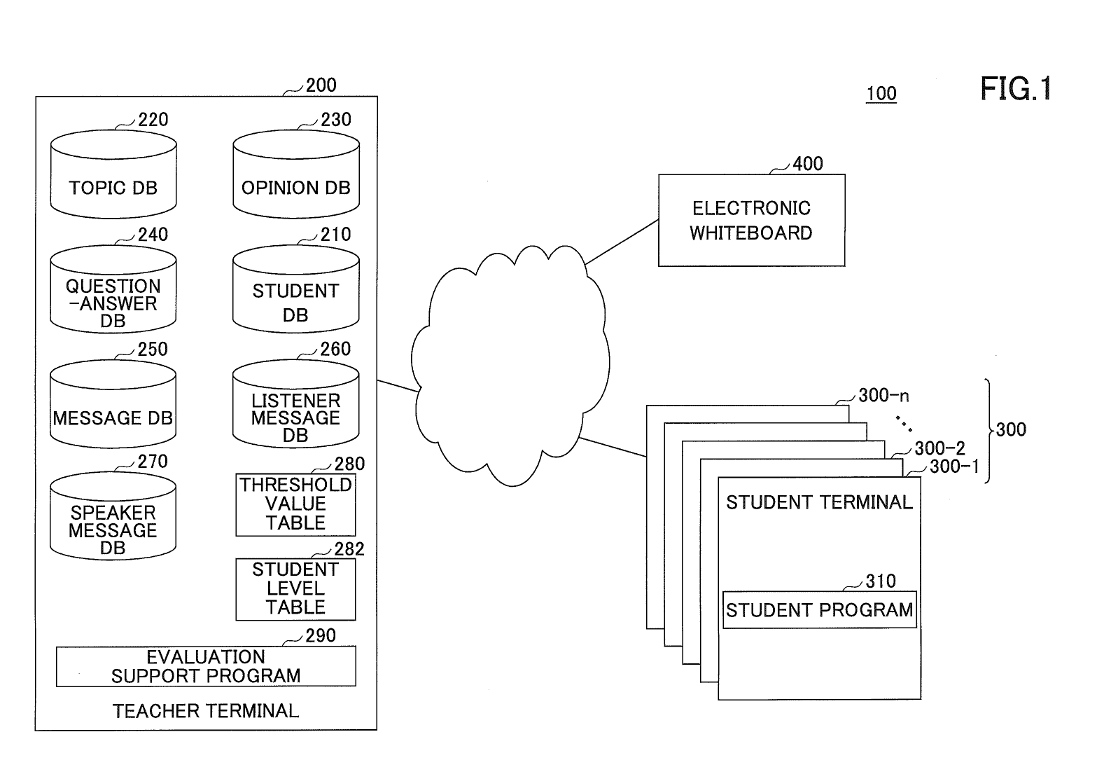

In the following, a first embodiment is described with reference to the accompanying drawings. FIG. 1 illustrates an example system configuration of an evaluation support system according to a first embodiment.

An evaluation support system 100 according to the first embodiment includes an evaluation support server 200, a plurality of terminal devices 300-1, 300-2, . . . , and 300-n, and an electronic whiteboard 400. The evaluation support server 200, the terminal devices 300, and the electronic whiteboard 400 are connected to each other via a network. Note that, in this embodiment, when the terminal devices 300-1, 300-2, . . . , and 300-n are not distinguished one from another, the term “terminal device(s) 300” is used.

The evaluation support server 200 in this embodiment is a terminal device which is used mainly by a teacher. In this regard, in the following description, the evaluation support server 200 is called a “teacher terminal 200”. Further, the terminal devices 300 in this embodiment are the terminal devices that are used mainly by the students who have a class. In this regard, in the following description, the terminal device(s) 300 is called a student terminal(s) 300.

The teacher terminal 200 and the student terminals 300 in this embodiment may be respective tablet terminals. Alternatively, the teacher terminal 200 and the student terminals 300 may be desktop or laptop computers. Further, for example, one of the teacher terminal 200 and the student terminals 300 may be a laptop computer and the other is a tablet terminal. The electronic whiteboard 400 in this embodiment may be, for example, a display device such as a large display.

The teacher terminal 200 in this embodiment includes a student database 210, a topic database 220, an opinion database 230, a question-answer database 240, a message database 250, a listener message database 260, and a speaker message database 270. The teacher terminal 200 in this embodiment further includes a threshold value table 280 and a student level table 282. In the teacher terminal 200 in this embodiment, an evaluation support program 290 is installed.

In the student terminals 300, a student program 310 is installed.

In the following, an example class style is described in which the evaluation support system 100 is used.

In this embodiment, the teacher terminal 200 transmits information indicating a topic to the student terminals 300, and receives information indicating students' opinions about the topic which are input to the student terminals 300 by the students. Those students' opinions are displayed as a list on the electronic whiteboard 400.

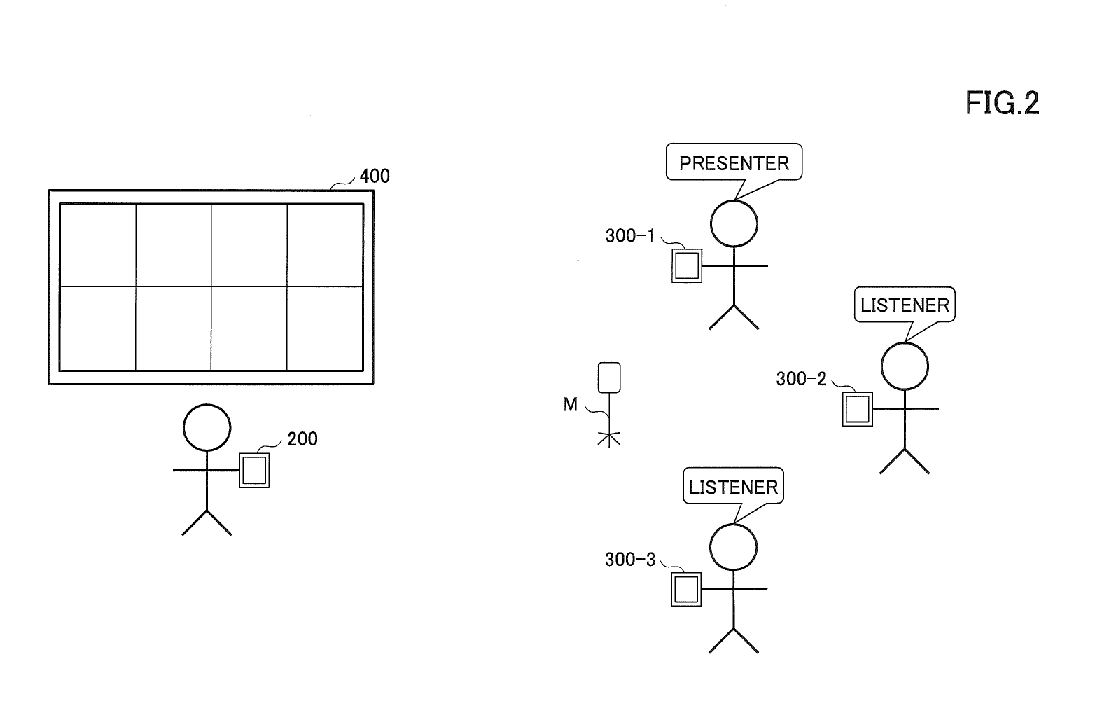

In this embodiment, the teacher selects an opinion to be presented from a list of the opinions displayed on the electronic whiteboard 400, so that the student who input the selected opinion to student terminal 300 is a presenter. Further, the students other than the presenter are “audiences” who listen to the presentation. In the example of FIG. 2, the student having the student terminal 300-1 is the presenter, and the students having the student terminals 300-2 and 300-3 are the audience members who listen to the presentation by the presenter.

The student, who is selected as the presenter, orally presents his/her opinion about the topic. The content of the presentation is recorded by a microphone M, stored in the teacher terminal 200 as a voice sound file, and used to check the content of the presentation later. Here, the microphone M may be installed, for example, in a class room, the electronic whiteboard 400, or in the student terminals 300.

After the presentation of the opinion by the presenter is finished, the teacher terminal 200 causes the student terminals 300-2 and 300-3 to display a question-answer screen which displays the question(s) about the content of the presentation by the presenter and an input column(s) to input the answer(s) to the question(s), and receives the input answers. Further, upon receiving the answers, the teacher terminal 200 collects information about ability to speak/communicate of the student presenter and information about ability to listen of the students who input the answers based on the questions, and displays evaluations of the abilities based on the collected information on the teacher terminal 200.

More specifically, in this embodiment, by asking the students, who have listened to the presentation by the presenter, to answer the questions about the content of the presentation, an evaluation is made how much of the content of the presentation the presenter can make the students understand. The result of the evaluation indicates (becomes) the ability to speak/communicate of the student as the presenter.

Similarly, by asking the students to answer questions about the content of the presentation, an evaluation is made how much the students, who have listened to the presentation by the presenter, can understand (listen to) the content of the presentation. The result of the evaluation indicates the ability to listen (understand) of the students as audience members.

As described above, according to this embodiment, by providing the evaluations of the ability to speak/communicate and the ability to listen of the students to the teacher, it becomes possible to support the teacher to evaluate the abilities of the students.

In the following description, the student of the presenter is called a “speaker”, and the student who listen to the presentation of the speaker is called a “listener”. Further, the term “ability to listen” herein refers to, for example, the ability to try to carefully listen and understand the content of the presentation, and the term “ability to speak/communicate” herein refers to, for example, the ability to organize and present information and ideas.

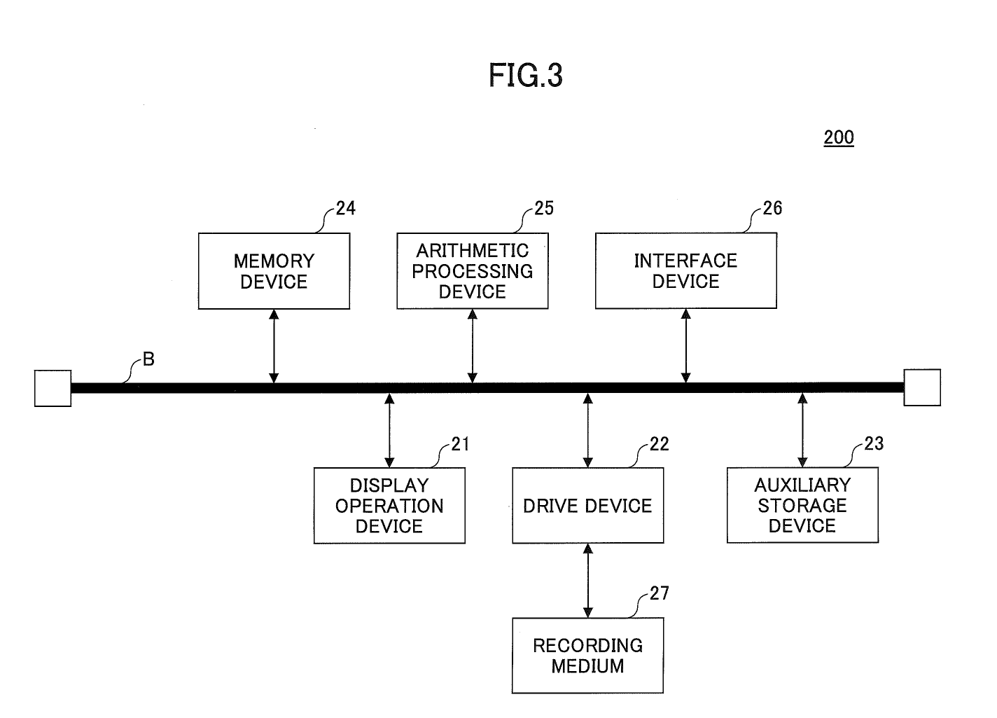

FIG. 3 illustrates an example hardware configuration of the teacher terminal 200. The teacher terminal 200 in this embodiment includes a display operation device 21, a drive device 22, an auxiliary storage device 23, a memory device 24, an arithmetic processing device 25, and an interface device 26, which area connected to each other via a bus B.

The display operation device 21 is, for example, a touch panel and is used to input various signals and display various information.

The interface device 26 includes a modem, a LAN card, etc., and is used to connect to the network.

The evaluation support program 290 is at least a part of various programs that control the teacher terminal 200. The evaluation support program 290 is provided by, for example, distribution of a recording medium 27 or downloading from the network. As the recording medium 27 storing the evaluation support program 290, various types of recording media can be used such as a recording medium which stores information optically, electronically, or magnetically like a compact disk read only memory (CD-ROM), a flexible disk, a magneto-optical disk, etc., and a semiconductor memory which stores information electronically like a ROM, a flash memory, etc.

Further, when the recording medium 27 storing the evaluation support program 290 is set in the drive device 22, the evaluation support program 290 is installed in the auxiliary storage device 23 from the recording medium 27 via the drive device 22. The evaluation support program 290 which has been downloaded from the network is installed in the auxiliary storage device 23 via the interface device 26.

The auxiliary storage device 23 stores not only the installed evaluation support program 290 but also necessary files and data, etc. The memory device 24 reads the evaluation support program 290 from the auxiliary storage device 23 and stores the evaluation support program 290 in the memory device 24 when the computer thereof starts up. Then, the arithmetic processing device 25 performs various processes described below in accordance with the evaluation support program 290 stored in the memory device 24.

Further, the teacher terminal 200 in this embodiment may be, for example, a desktop computer or a laptop computer. In this case, the teacher terminal 200 includes an input device such as a keyboard and a mouse, etc., and a display, etc., in place of the display operation device 21.

The hardware configuration of the student terminal 300 in this embodiment is similar to that of the teacher terminal 200, and the repeated description thereof is herein omitted.

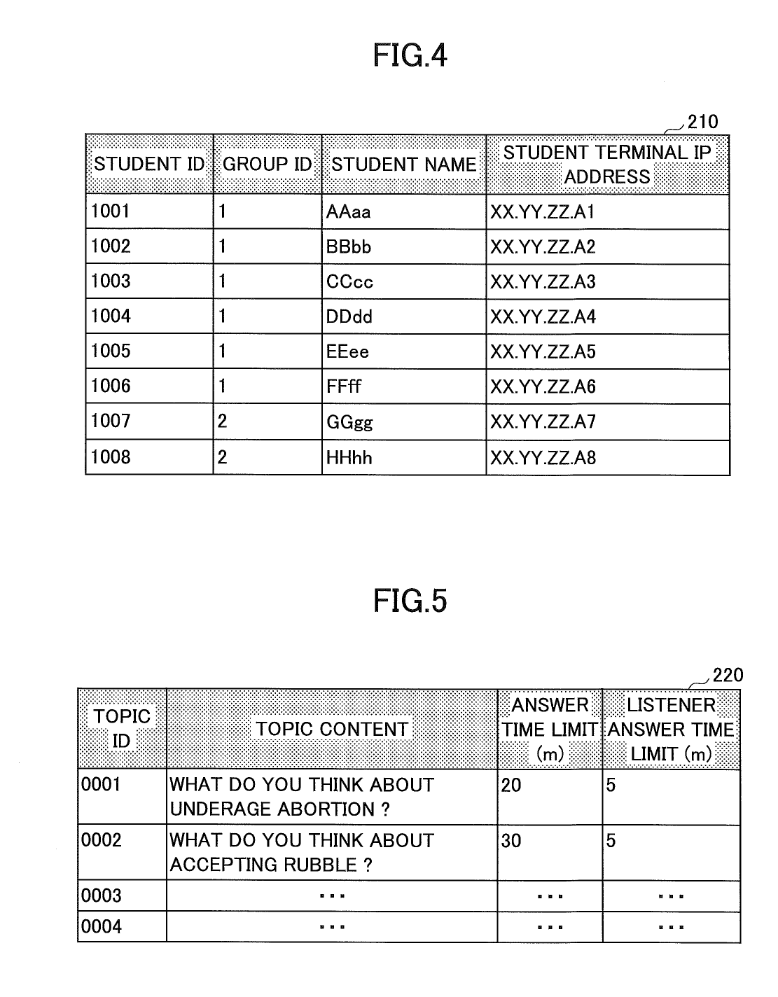

With reference to FIGS. 4 through 12, various databases and tables described are stored in the teacher terminal 200. The databases and tables in this embodiment are stored, for example, in a predetermined area of the auxiliary storage device 23, the memory device 24, etc., in the teacher terminal 200.

FIG. 4 illustrates an example of a student database 210. The student database 210 in this embodiment is registered in advance by, for example, a teacher who operates the teacher terminal 200. The information items of the student database 210 include a student identifier (student ID) allocated to each of the student terminals 300, a group ID which distinguishes groups of students, student name, and the IP address of the student terminal 300. In the student database 210, the student identifier is associated with other items. In the following description, a value of the student identifier and values of the items associated with the student identifier are collectively called “student information”.

Further, in the student database 210 in this embodiment, it is assumed that one group ID is allocated to the students on a class basis.

FIG. 5 illustrates an example of a topic database 220. The topic database 220 in this embodiment is registered in advance by, for example, the teacher who operates the teacher terminal 200.

The information items of the topic database 220 includes a topic ID which is allocated on a topic basis, topic content, an answer time limit, and a listener answer time limit in a manner such that the topic ID is associated with other items.

The topic content refers to text data of an actual topic. The answer time limit refers to a time limit when an answer (opinion) about the topic is to be input. The listener answer time limit refers to a time limit when the listener answers a question about the content of presentation after a speaker finishes his/her presentation of the opinion about the topic.

The “topic” in the following descriptions refers to text data which is a value of the item “topic content”.

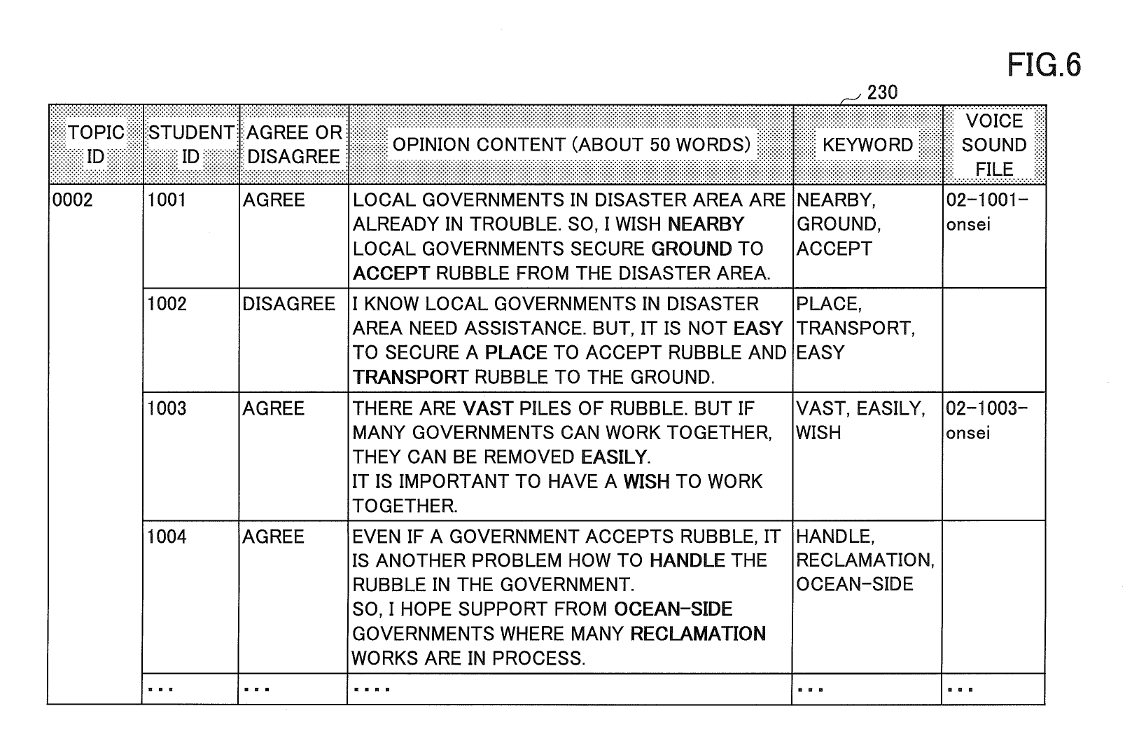

FIG. 6 illustrates an example of an opinion database 230. The opinion database 230 in this embodiment is provided on a topic basis. The information items of the opinion database 230 include the topic ID, the student ID, agree or disagree, opinion content, a keyword, and a voice sound file, in a manner such that the student ID is associated with other items on a topic ID basis.

The agree or disagree in this embodiment refers to the agree or disagree by the students of the topic ID and the corresponding topic, and is input from the student terminal 300 identified by the student ID. The opinion content refers to an opinion of the student about the topic ID and the corresponding topic, and is the text data that are input from the student terminal 300 identified by the student ID. In the following, the opinion (text data) which is input from the student terminal 300 is called “opinion data”.

The keyword refers to a keyword designated by the student from the student terminal 300 and a keyword which is included in the opinion data input from the student terminal 300. The voice sound file refers to a name of the voice sound file in which voice sound is recorded when the student identified by the student ID was the presenter.

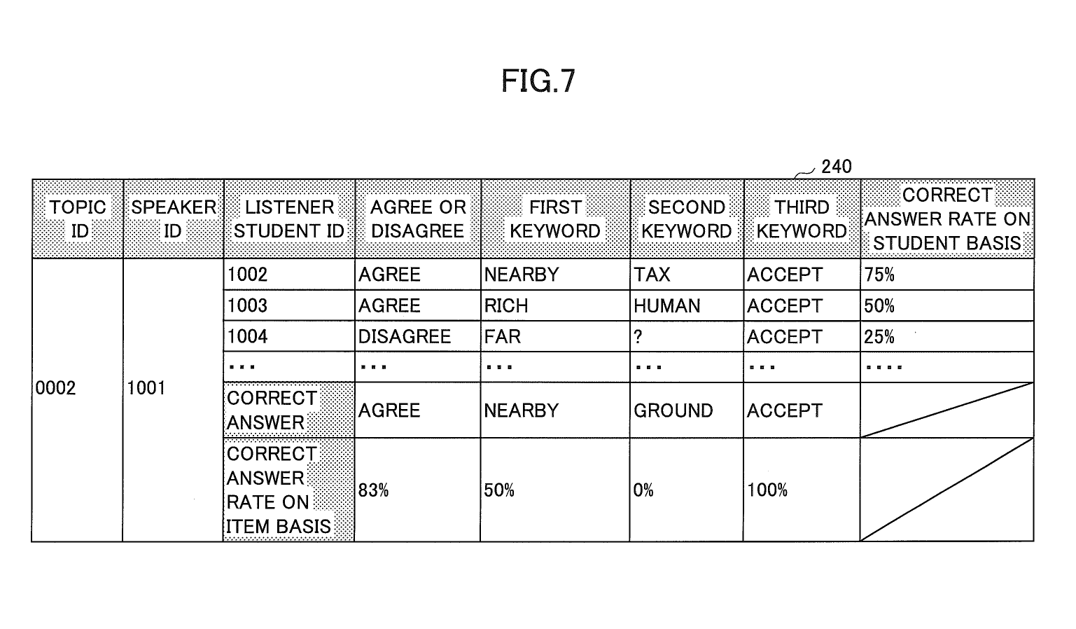

FIG. 7 illustrates an example of a question-answer database 240. The question-answer database 240 in this embodiment may be provided on a topic ID basis. The question-answer database 240 in this embodiment stores the answers to the questions about the content of the presentation by a speaker, the correct answers of the questions, and a correct answer rates of the questions.

The information items of the question-answer database 240 in this embodiment include the topic ID and a speaker ID which are associated with each other. Further, the question-answer database 240 includes a listener student ID, the agree or disagree, a first keyword, a second keyword, a third keyword, and a student correct answer rate (correct answer rate on a student basis).

Here, the values of the information items “agree or disagree”, the “first keyword”, the “second keyword”, and the “third keyword” correspond to the answers of the question about the content of the presentation input from the student terminal 300 identified by the listener student ID.

The student correct answer rate is in association with the listener student ID, and refers to the correction answer rate of the student identified by the listener student ID.

In the question-answer database 240, the speaker ID refers to the student ID of the student selected as the presenter. The listener student ID refers to the student ID of the student other than the presenter corresponding to the group ID same as that of the speaker ID.

Further, in the question-answer database 240, the items of the answer correspond to “agree or disagree”, the “first keyword”, the “second keyword”, and the “third keyword”, and as the corresponding values of those items, there are provided the correct answer, and the correct answer rates of the items.

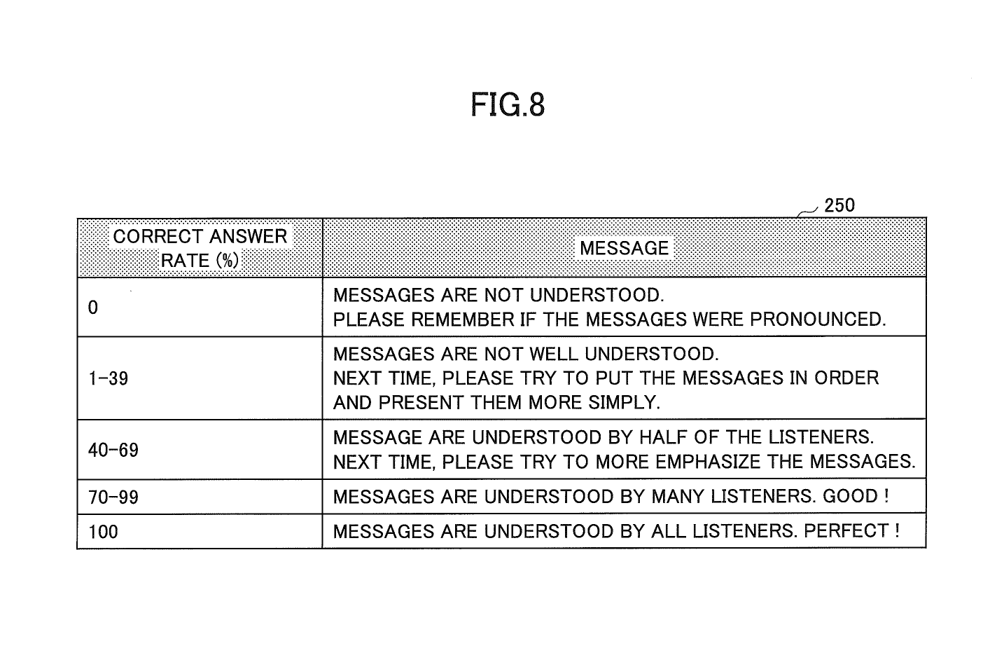

FIG. 8 illustrates an example of a message database 250. The information items of the message database 250 in this embodiment include the correct answer rate and the messages corresponding to the correct answer rate, which are stored in association with each other.

The message database 250 in this embodiment stores the messages to be displayed on the student terminal 300 of the student who was the speaker in accordance with the correct answer rates of the listeners and of the questions about the content of the presentation. The messages are used to inform the evaluation of the ability as the speaker.

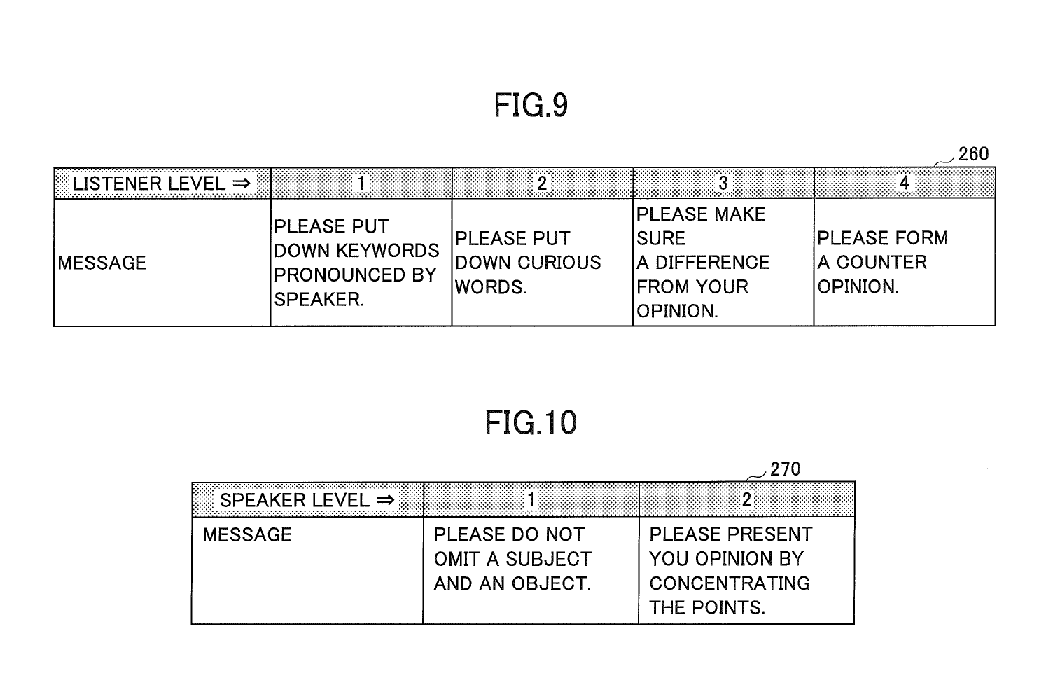

FIG. 9 illustrates an example of a listener message database 260. The information items of the listener message database 260 in this embodiment include values of the listener (ability) level and the messages corresponding to the values. The messages stored in FIG. 9 will be displayed on the student terminals 300 of the listeners.

The listener message database 260 in this embodiment may be registered in advance by, for example, the teacher.

FIG. 10 illustrates an example of a speaker message database 270. The information items of the speaker message database 270 include values of the speaker (ability) level and the messages corresponding to the values. The messages stored in FIG. 10 will be displayed on the student terminal 300 of the speaker.

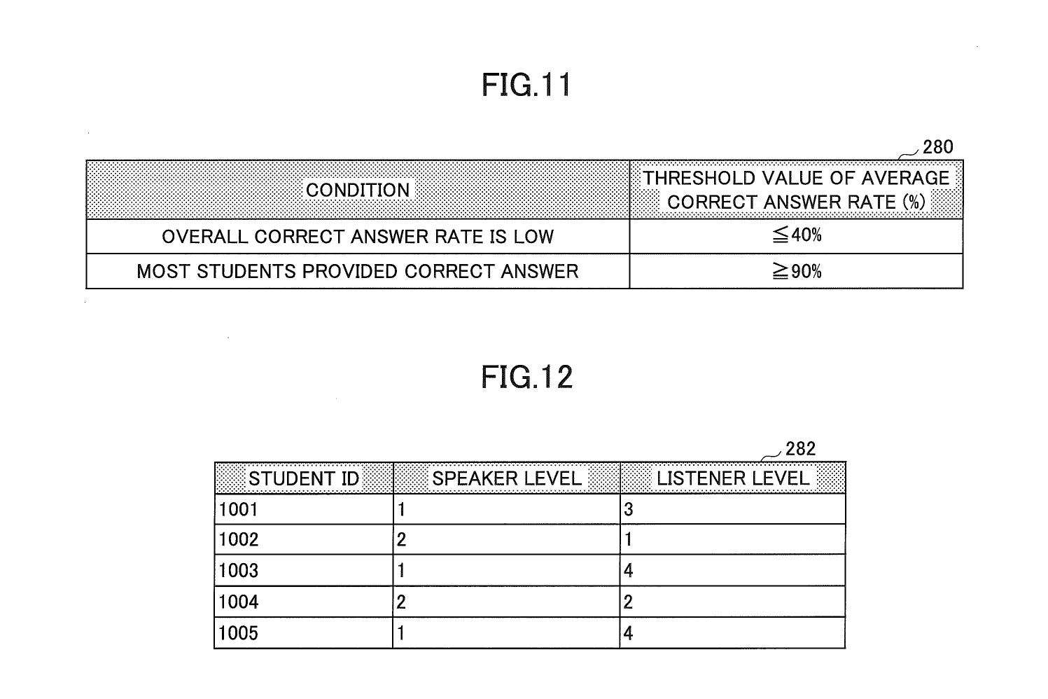

FIG. 11 illustrates an example of a threshold value table 280. The threshold value table 280 in this embodiment is stored in advance in the teacher terminal 200 by, for example, the teacher.

The threshold value table 280 in this embodiment is stored in a manner such that a condition is in association with a threshold value of the average correct answer rate, and is referred to when the ability to listen of the students as the listeners is evaluated.

The “condition” in this embodiment refers to a condition related to the correct answer rate in the question-answer database 240. The average correct answer rate refers to an average of the correct answer rate of each of answering items. The answering items refer to the items of the “agree or disagree”, the “first keyword”, the “second keyword”, and the “third keyword”. The threshold value of the average correct answer rate refers to a threshold value to use to determine whether the condition is satisfied. In the example of FIG. 11, when the average correct answer rate is less than or equal to 40%, it is determined that the correct answer rate is low.

FIG. 12 illustrates an example of a student level table 282. The student level table 282 in this embodiment is stored in advance in the teacher terminal 200 by, for example, the teacher.

In the teacher terminal 200 in this embodiment, the student ID is stored in association with a speaker level and a listener level.

The teacher terminal 200 in this embodiment is referred to when, for example, the message stored in the listener message database 260 or the speaker message database 270 is displayed

For example, when the student of the student ID “1001” is the speaker, the speaker level of the student is “1”. Therefore, the teacher terminal 200 causes the student terminal 300 of the student to display the message “please do not omit a subject and an object” stored in the speaker message database 270.

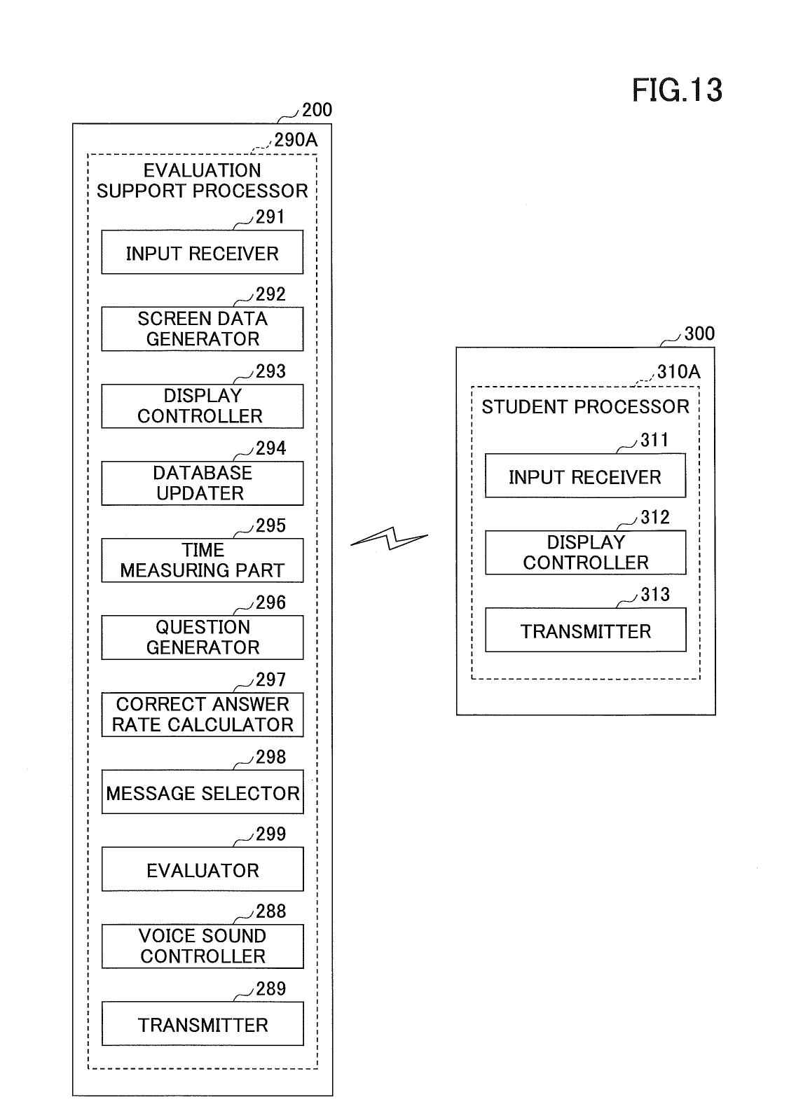

Next, with reference to FIG. 13, the functions of the teacher terminal 200 and the student terminal 300 of the evaluation support system 100 are described.

FIG. 13 illustrates the functions of the teacher terminal 200 and the student terminal 300. First, the functions of the teacher terminal 200 are described.

The teacher terminal 200 in this embodiment realizes an evaluation support processor 290A when the arithmetic processing device 25 executes the evaluation support program 290.

The evaluation support processor 290A in this embodiment includes an input receiver 291, a screen data generator 292, a display controller 293, a database updater 294, and a time measuring part 295. The evaluation support processor 290A in this embodiment further includes a question generator 296, a correct answer rate calculator 297, a message selector 298, an evaluator 299, a voice sound controller 288, and a transmitter 289.

The input receiver 291 in this embodiment accepts the input to the teacher terminal 200. The input receiver 291 in this embodiment accepts, for example, the information from an external apparatus such as the student terminal 300, etc., and the input of the information from the display operation device 21.

The screen data generator 292 generates the data of the screens to be displayed on the teacher terminal 200, the student terminals 300, and the electronic whiteboard 400. The display controller 293 controls the display of the display operation device 21 of the teacher terminal 200. The database updater 294 updates the various databases. The time measuring part 295 measures an elapsed time by using a time function of the teacher terminal 200.

The question generator 296 in this embodiment refers to the opinion database 230, and generates the questions to be displayed on the student terminals 300 of the listeners. The correct answer rate calculator 297 calculates the correct answer rates based on the answers to the questions collected from the student terminals 300 of the listeners. The message selector 298 selects a message to be displayed on the student terminals 300 of the listeners in accordance with the correct answer rates. The evaluator 299 evaluates the abilities of the speaker and the listeners. Details of the processes, which are performed by the question generator 296, the correct answer rate calculator 297, the message selector 298, and the evaluator 299, are described below.

The voice sound controller 288 controls the recording and reproduction of the presentation content of the presenter. The transmitter 289 transmits various data from the teacher terminal 200 to external apparatuses.

Next, the functions of the student terminal 300 are described.

The student terminal 300 in this embodiment realizes a student processor 310A when an arithmetic processing device executes the student program 310.

The student processor 310A in this embodiment includes an input receiver 311, a display controller 312, and a transmitter 313. The input receiver 311 accepts input of the information from an external apparatus such as, for example, the teacher terminal 200 and input of the information from the display operation device of the student terminal 300. The display controller 312 controls the display of the display operation device based on the screen data received from the teacher terminal 200. The transmitter 313 transmits the information, which is input from the student terminal 300, to the teacher terminal 200.

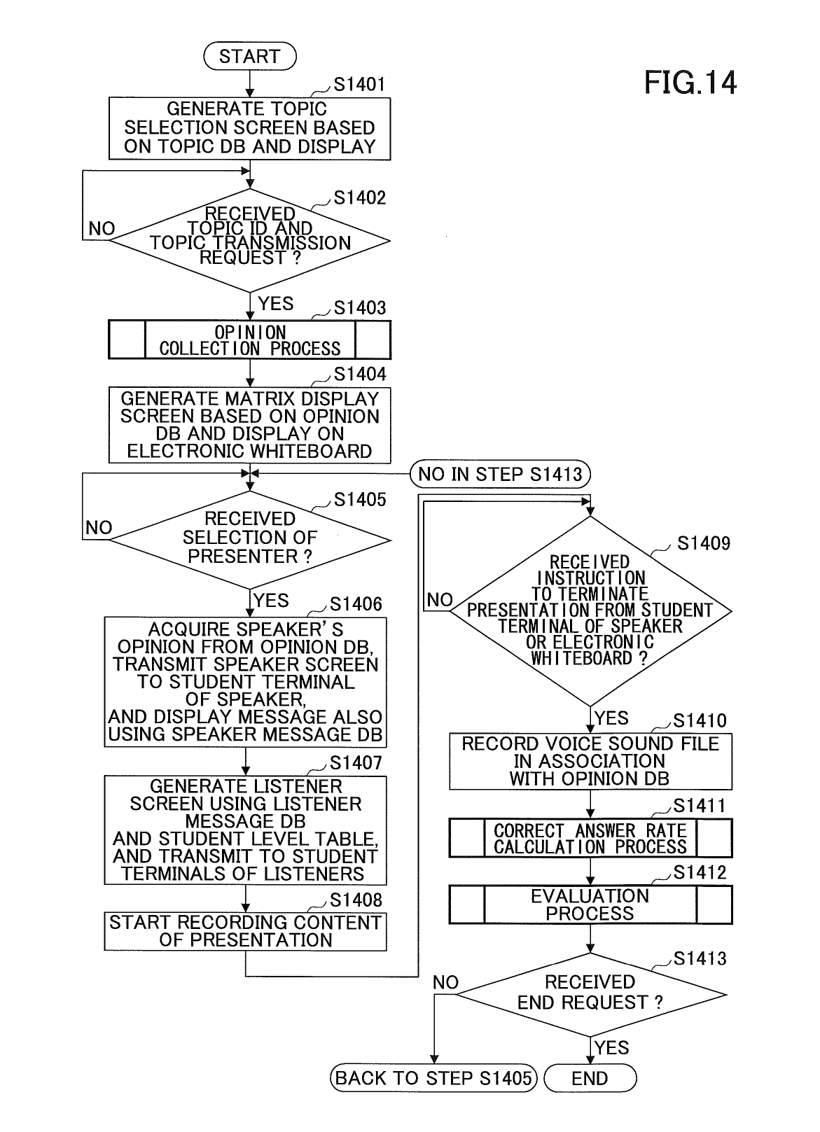

Next, the operations of the teacher terminal 200 in the evaluation support system 100 according to this embodiment are described. FIG. 14 is a flowchart of the operations of the teacher terminal 200. FIG. 14 illustrates an example of operations of the teacher terminal 200 in a class style where the students input their opinions about a topic.

The teacher terminal 200 in this embodiment causes the screen data generator 292 to refer to the topic database 220 and generate the screen data of a topic selection screen, and causes the display controller 293 to display the topic selection screen on the display operation device 21 (step S1401). Further, the teacher terminal 200 causes the input receiver 291 to determine whether the selection of the topic is received (step S1402). More specifically, the input receiver 291 determines whether the selection of the topic ID and a transmission request to transmit the topic are received. When no selection of the topic is selected in step S1402, the teacher terminal 200 waits for the reception of the selection.

When the selection of a topic is received in step S1402, the teacher terminal 200 performs an opinion collection process (step S1403). The opinion collection process herein refers to a process of collecting information including the opinion data which are input from the student terminals 300 about the selected topic and storing the collected information in the opinion database 230. More detail of the opinion collection process is described below.

The teacher terminal 200 causes the screen data generator 292 to refer to the opinion database 230 and generate the screen data of a matrix display screen where a list of the opinion data of the students is displayed in a matrix manner. Further, the teacher terminal 200 causes the transmitter 289 to transmit the generated screen data to the electronic whiteboard 400, so that the matrix display screen is displayed (step S1404).

Then, the teacher terminal 200 causes the input receiver 291 to determine whether the selection of the student, who becomes the presenter (speaker), by the teacher is received (step S1405).

Further, in this embodiment, the matrix display screen, which is displayed on the electronic whiteboard 400, may be displayed on the teacher terminal 200. Further, in this embodiment, for example, the selection of the presenter may be performed by selecting the opinion of the student displayed on the matrix display screen on the electronic whiteboard 400 or the teacher terminal 200.

In step S1405, when no selection is received, the teacher terminal 200 waits for receiving the selection.

In step S1405, when the selection of the presenter is received, the teacher terminal 200 causes the screen data generator 292 to acquire the opinion data of the student, who is selected as the presenter, from the opinion database 230 and generate the screen data of a speaker screen to be displayed on the student terminal 300 of the speaker. Then, the teacher terminal 200 causes the transmitter 289 to transmit the generated screen data to the student terminal 300 of the student who is selected as the speaker (step S1406).

Further, in this case, the message selector 298 may refer to the student level table 282 and acquire the student ID of the student selected as the speaker and the corresponding speaker level, so as to select a message, which corresponds to the speaker level, from the speaker message database 270. The screen data generator 292 generates the screen data in a manner such that the selected message is displayed on the speaker screen. The message displayed on the speaker screen includes, for example, suggestions to be taken care of when the speaker presents his/her opinion, etc.

Next, the teacher terminal 200 causes the message selector 298 to acquire the student IDs of the students who are other than the presenter and the corresponding listener levels from the student level table 282 and select the messages corresponding to the listener levels by referring to the listener message database 260. Then, the teacher terminal 200 causes the screen data generator 292 to generate the screen data of listener screens including the corresponding selected messages and causes the transmitter 289 to transmit the generated screen data to the student terminals 300 of the students as the listeners so as to display the listener screens (step S1407). In this embodiment, in the listener screens, for example, a message including suggestions to the listeners in hearing the presentation may be displayed.

Next, the teacher terminal 200 causes the voice sound controller 288 to start recording the content of the presentation performed by the speaker (step S1408).

In this embodiment, for example, when the speaker starts the presentation, power of the microphone M may be turned on. Further, in this embodiment, a case is described where the microphone M is used to record the content of the presentation. Note that, however, the present invention is not limited to this configuration. For example, the voice sound file may be acquired by capturing video images of the presenter by using a camera function provided in the teacher terminal 200 or the student terminal 300.

Next, the teacher terminal 200 causes the input receiver 291 to determine whether an end instruction of the presentation is received (step S1409).

In this embodiment, to determine the end of the presentation, for example, an operation button to indicate the end of the presentation is displayed on the student terminal 300 of the speaker and/or the electronic whiteboard 400, so that the teacher terminal 200 can receive the end instruction of the presentation when the operation button is operated.

In step S1409, when no end instruction is received, the teacher terminal 200 waits for the reception of the end instruction. When the end instruction is received in step S1409, the teacher terminal 200 acquires the voice sound file, and stores the file name of the voice sound file in association with the student ID of the speaker in the opinion database 230 (step S1410).

Further, in this embodiment, a case is described where the voice sound file is stored in the opinion database 230. Note that, however, the present invention is not limited to this configuration. For example, the voice sound file in which the content of the presentation is recorded may be stored in the student terminal 300 of the speaker. In this case, in the opinion database 230, the file name of the voice sound file is stored.

Next, the teacher terminal 200 performs a correct answer rate calculation process to calculate the correct answer rate by collecting the answers of the listeners (step S1411). Then, the teacher terminal 200 performs an evaluation process to evaluate the ability to speak/communicate of the speaker and the ability to listen (understand) of the listeners (step S1412). Details of the correct answer rate calculation process and the evaluation process are described below.

Next, the teacher terminal 200 determines whether the end instruction is received (step S1413). In step S1413, when determining that no end instruction is received, the process of the teacher terminal 200 goes back to step S1405. When the end instruction is received in step S1413, the process of the teacher terminal 200 ends.

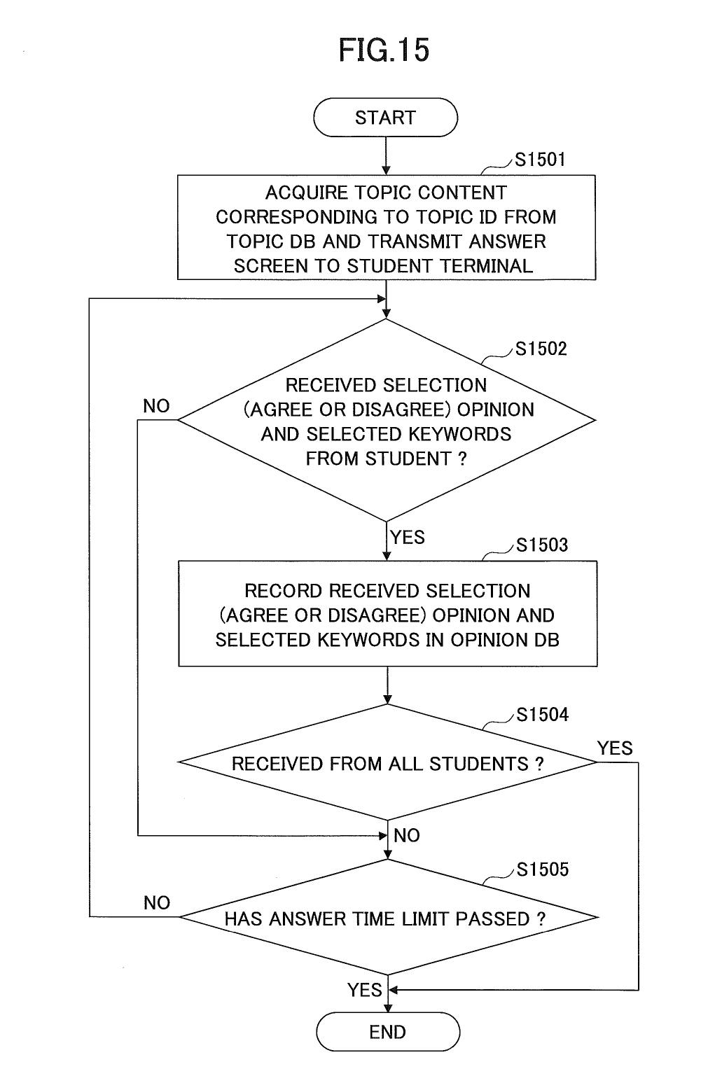

Next, the opinion collection process performed by the teacher terminal 200 is described with reference to FIG. 15. FIG. 15 is a flowchart of an example of the opinion collection process performed by the teacher terminal 200. The opinion collection process is performed in step S1403 of FIG. 14.

The teacher terminal 200 in this embodiment causes the screen data generator 292 to acquire the topic ID and the corresponding topic content by referring to the topic database 220 and generate the screen data of a topic answer screen. Then, the teacher terminal 200 causes the transmitter 289 to transmit the generated screen data to the student terminals 300 (step S1501). The topic answer screen in this embodiment refers to a screen including a choice of agree or disagree about the topic and an opinion input column to input opinion data about the topic, so that the student can designate keywords, which are thought to be important by the student, in the opinion data. Details of the topic answer screen are described below.

Next, the teacher terminal 200 causes the input receiver 291 to determine whether the choice of agree or disagree, the opinion data, and the designated keywords about the topic are input (step S1502). Further, in this embodiment, the choice of agree or disagree, the opinion data, and the designated keywords from the opinion data are collectively called “opinion information”.

In step S1502, when determining that no opinion information is received in step S1502, the process of the teacher terminal 200 goes to step S1505 which is described below.

When determining that the opinion information is received in step S1502, the teacher terminal 200 causes the database updater 294 to store the received opinion information in association with the student ID in the opinion database 230 (step S1503). Here, the student ID is identified based on the IP address of the student terminal 300 which is the transmission source of the received opinion information and the student database 210.

Next, the teacher terminal 200 determines whether the opinion information is received from all students (step S1504). Here, all the students refers to all the students to which the same group ID is applied in the student database 210.

In step S1504, when determining that the opinion information is received from all the students, the teacher terminal 200 terminates the opinion collection process.

In step S1504, when determining that the opinion information is not received from all the students, the teacher terminal 200 refers to the topic database 220 and causes the time measuring part 295 to determine whether the answer time limit corresponding to the topic ID has passed (step S1505). Here, the teacher terminal 200 may cause the time measuring part 295 to start the measurement when the screen data of the topic answer screen is transmitted to the student terminals 300.

In step S1505, when the answer time limit has not passed, the process of the teacher terminal 200 goes back to step S1502. In step S1505, when the answer time limit has passed, the teacher terminal 200 terminates the opinion collection process.

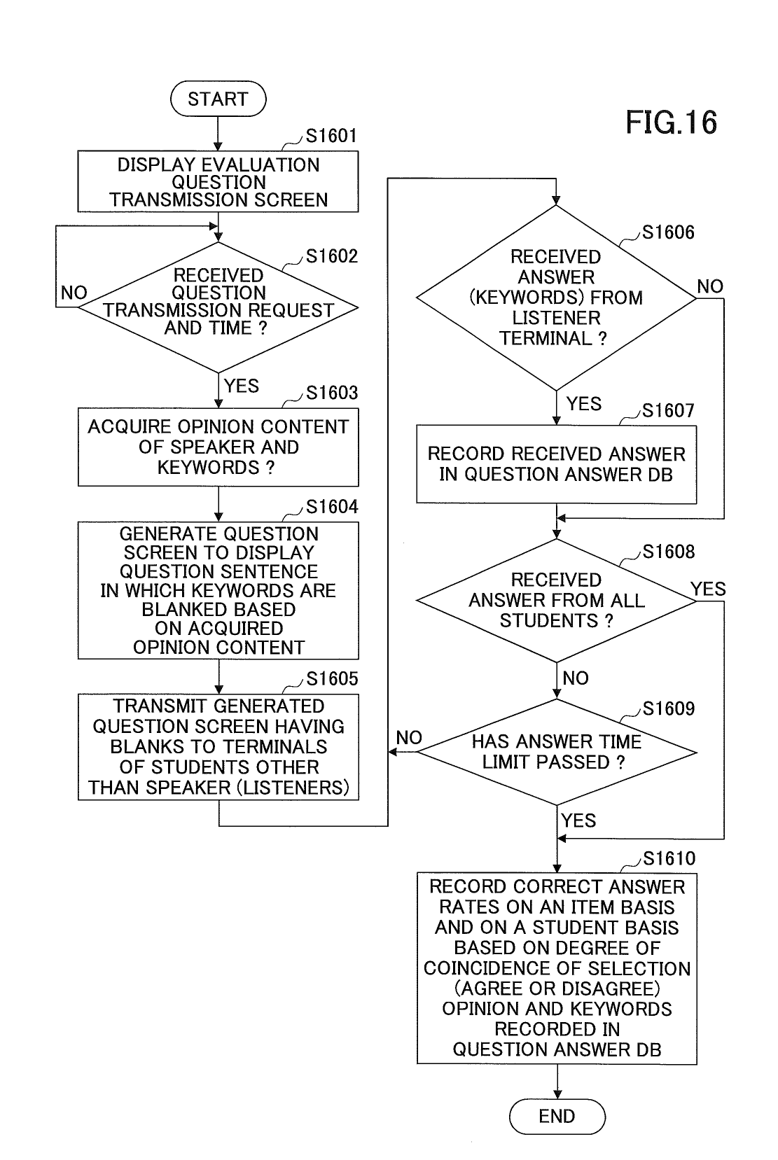

Next, the correct answer rate calculation process performed by the teacher terminal 200 is described with reference to FIG. 16. FIG. 16 is a flowchart of the correct answer rate calculation process in the teacher terminal 200. The correct answer rate calculation process is performed in step S1411 of FIG. 14.

The teacher terminal 200 in this embodiment causes the screen data generator 292 to generate the screen data of a transmission screen to transmit evaluation questions, and causes the display controller 293 to display the transmission screen (step S1601). Next, the teacher terminal 200 causes the input receiver 291 to determine whether the inputs of a question transmission request and a listener answer time limit are received (step S1602).

In step S1602, when determining that the inputs are not received, the teacher terminal 200 waits for the reception of the inputs.

When determining that the inputs are received in step S1602, the teacher terminal 200 causes the question generator 296 to acquire the student ID of the student who is selected as the speaker and the corresponding opinion content and the keywords from the opinion database 230 (step S1603). Next, based on the acquired opinion, the teacher terminal 200 causes the question generator 296 to generate a question sentence including blank columns where the keywords are deleted. Then, the teacher terminal 200 causes the screen data generator 292 to generate the screen data of the question answer screen in which the question sentence including the blank columns is described (step S1604). Next, the teacher terminal 200 causes the transmitter 289 to transmit the screen data of the question answer screen to the student terminals 300 of the students who are other than the speaker, that is, who are the listeners (step S1605) so that the question answer screen is displayed on the student terminals 300.

In the question answer screen, a screen is displayed in which the keywords, which are thought to be important in the speaker's opinion and thus designated due to the importance, are deleted in the blank columns. In this embodiment, the student listener answers the questions by filling the blank columns based on the content of the presentation. Details of the question answer screen are described below.

Next, the teacher terminal 200 causes the input receiver 291 to determine whether the answers to the questions are received from the student terminals 300 of the listeners (step S1606). When determining that no answer is received in step S1606, the process of the teacher terminal 200 goes to step S1608 which is described below.

In step S1606, when determining that the answer is received, the teacher terminal 200 causes the database updater 294 to store the answer, which is received from the student terminal 300, in the question-answer database 240 (step S1607). Further, in this embodiment, the keywords, which are input in the blank columns correspond to the answer. In this case, the database updater 294 stores the answer in association with the IP address of the student terminal 300 of the transmission source and the corresponding student ID (listener student ID).

Next, the teacher terminal 200 determines whether the answer is received from all listeners (step S1608). When determining that the answer is received from all listeners in step S1608, the process of the teacher terminal 200 goes to step S1610 which is described below.

When determining that the answer is not received from all listeners in step S1608, the teacher terminal 200 causes the time measuring part 295 to determine whether the listener answer time limit has passed (step S1609). Here, the time measuring part 295 may start measuring the listener answer time limit when the screen data of the question answer screen are transmitted to the student terminals 300.

When determining that the listener answer time limit has passed in step S1609 or when determining that the answer is received from all listeners in step S1608, the teacher terminal 200 causes the correct answer rate calculator 297 to store the correct answer rate on a listener student basis and the correct answer rate on an item basis in the question-answer database 240, and terminates the process. The process performed by the correct answer rate calculator 297 is described below.

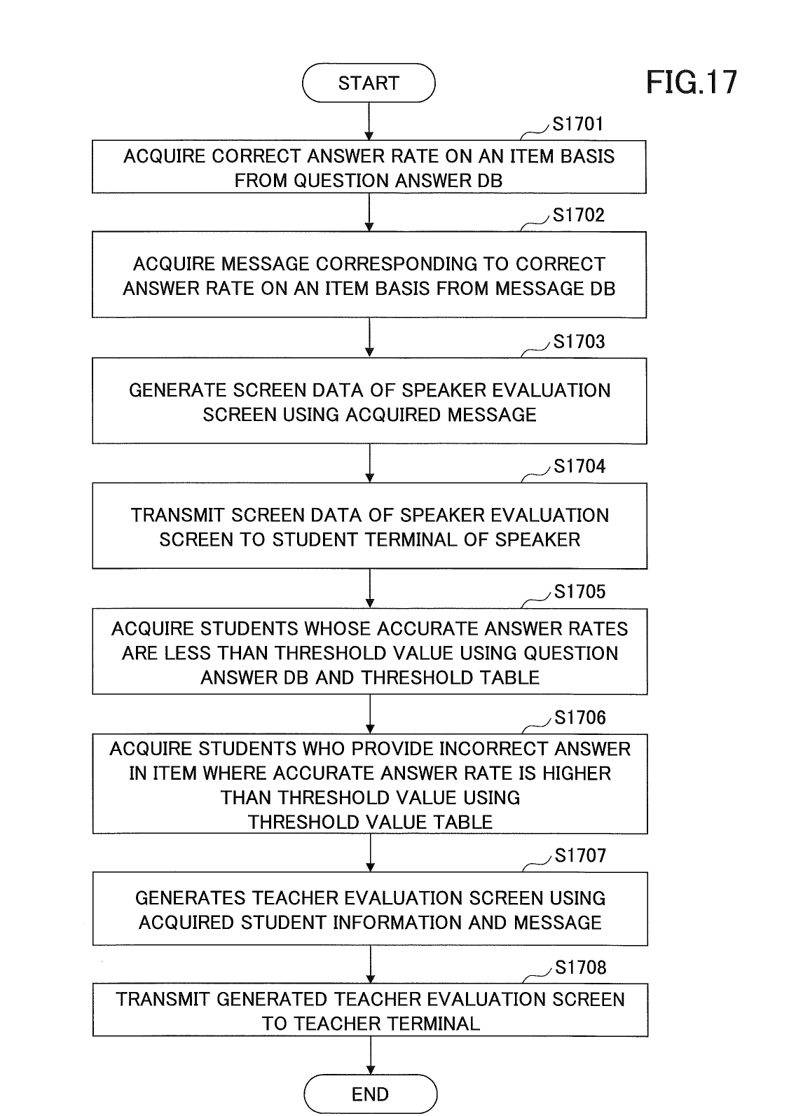

Next, the evaluation process performed by the teacher terminal 200 is describe with reference to FIG. 17. FIG. 17 is a flowchart of the evaluation process in the teacher terminal 200. The evaluation process is performed in step S1412 of FIG. 14.

The teacher terminal 200 in this embodiment causes the message selector 298 to acquire the correct answer rates on an item basis from the question-answer database 240 (step S1701). Next, the teacher terminal 200 causes the message selector 298 to acquire a message corresponding to the correct answer rates on an item basis from the message database 250 (step S1702).

Next, the teacher terminal 200 causes the screen data generator 292 to generate the screen data of a speaker evaluation screen to be displayed on the student terminal 300 of the student as the speaker (step S1703). Next, the teacher terminal 200 transmits the screen data to the student terminal 300 of the speaker, so as to display the speaker evaluation screen (step S1704).

Next, the teacher terminal 200 causes the evaluator 299 to refer to the threshold value table 280 and acquire the listener student IDs of the listeners whose student correct answer rates in the question-answer database 240 are less than or equal to the threshold value corresponding to the condition that “the correct answer rate is low” in the threshold value table 280 (step S1705). Next, the teacher terminal 200 causes the evaluator 299 to refer to the threshold value table 280 and acquire the listener student IDs of the students who input wrong answers in the item whose correct answer rate is higher than the correct answer rate corresponding to the condition that “many students input correct answer” (step S1706).

Next, the teacher terminal 200 causes the screen data generator 292 to generate the screen data of a teacher evaluation screen which includes the message acquired in step S1702, the listener student IDs acquired in steps S1705 and S1706, and the names of the corresponding students (step S1707). Then, the teacher terminal 200 causes the display controller 293 to display the teacher evaluation screen, which is based on the screen data generated in steps S1703 and S1707, on the display operation device 21 of the teacher terminal 200 (step S1708), and terminates the process. Details of the teacher evaluation screen are described below.

Further, in this embodiment, the evaluation process of FIG. 17 is described as a series of processes. Note that, however, the present invention is not limited to this configuration. In this embodiment, for example, the processes from step S1701 to step S1704 are performed in class hours, and then the process is temporarily terminated. Then, the processes after step S1705 may be independently performed in the teacher terminal 200 after the class hours.

Next, operations of the teacher terminal 200 are further described by referring to various examples of the screens in the evaluation support system 100 according to this embodiment.

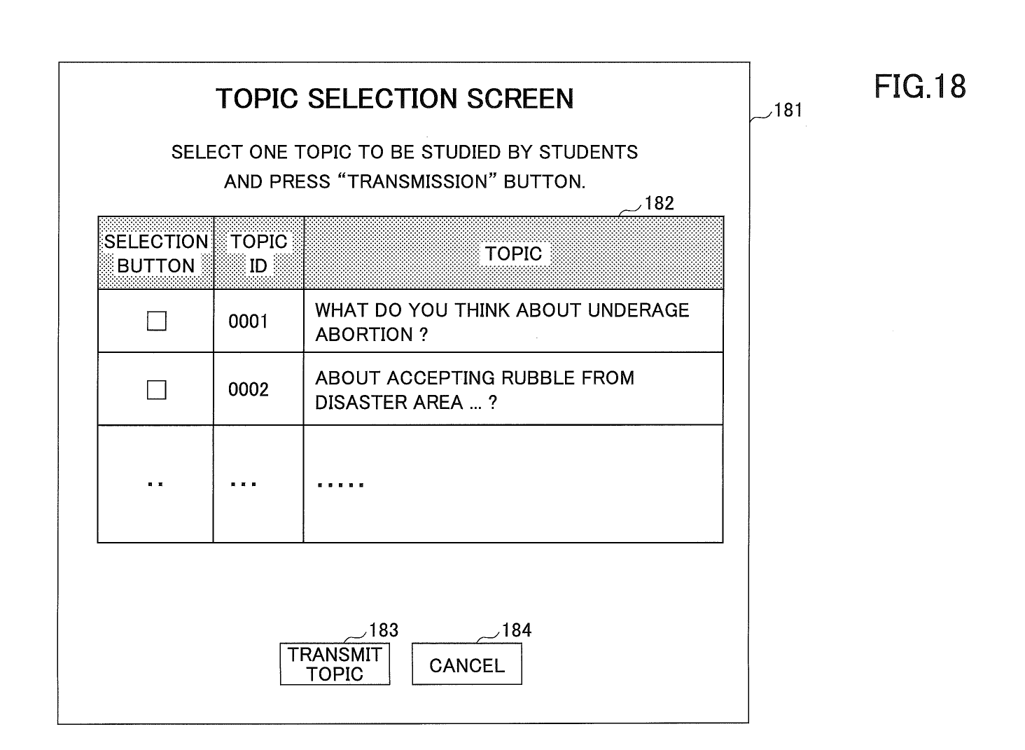

FIG. 18 illustrates an example of a topic selection screen 181 which is displayed on the teacher terminal 200. The topic selection screen 181 of FIG. 18 is displayed on the teacher terminal 200 in, for example, step S1401 of FIG. 14.

In the topic selection screen 181 of FIG. 18, a topic selection column 182, a topic transmission button 183 to request to transmit the selected topic, and a cancel button 184 to cancel the selection of the topic are displayed. In the topic selection screen 181 on the teacher terminal 200, when a selection button in the topic selection column 182 is operated and then the topic transmission button 183 is operated, the selected topic ID and the corresponding topic are transmitted to the student terminals 300.

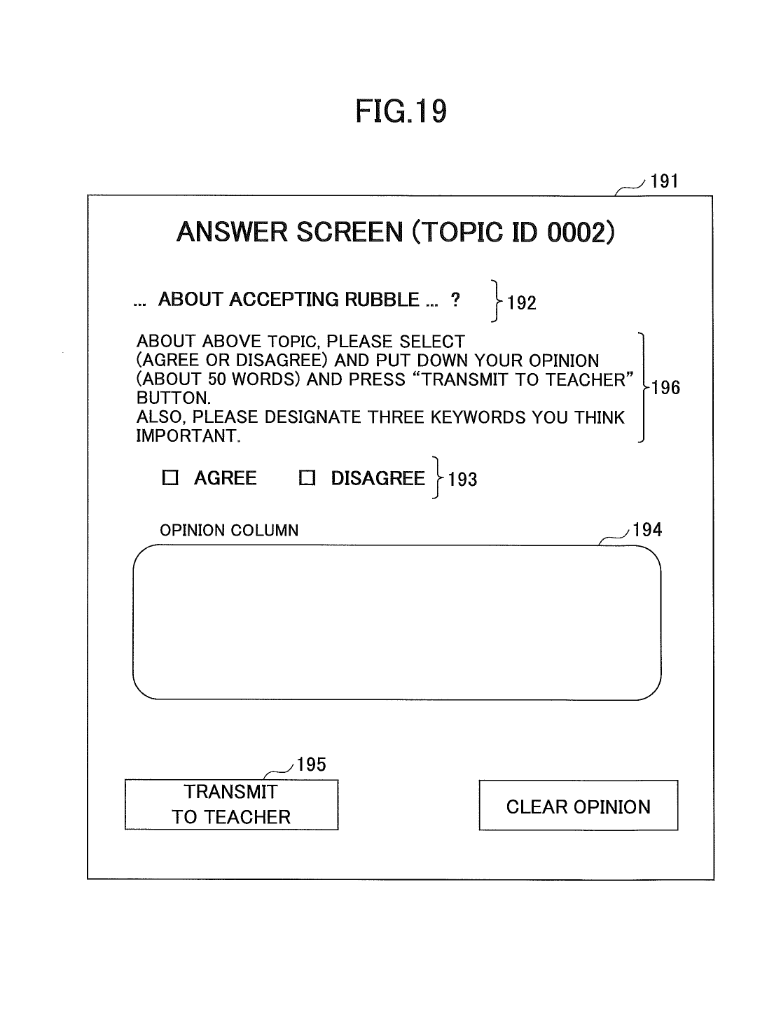

FIG. 19 illustrates an example of a question answer screen 191 which is displayed on the student terminals 300. For example, the question answer screen 191 of FIG. 19 is displayed on the student terminal 300 in step S1501 of FIG. 15.

In the question answer screen 191 in this embodiment, a topic content 192, a selection column 193 to select agree or disagree, an opinion input column 194 to input an opinion, and an opinion transmission button 195 to request to transmit the opinion information are displayed. Further, in the question answer screen 191, there is a description 196 which prompts the student who inputs the opinion to designate three keywords, which the student supposes important, from the opinion input in the opinion input column 194 by the student. In the example of FIG. 19, the topic ID “0002” corresponding to the topic content 192 is displayed.

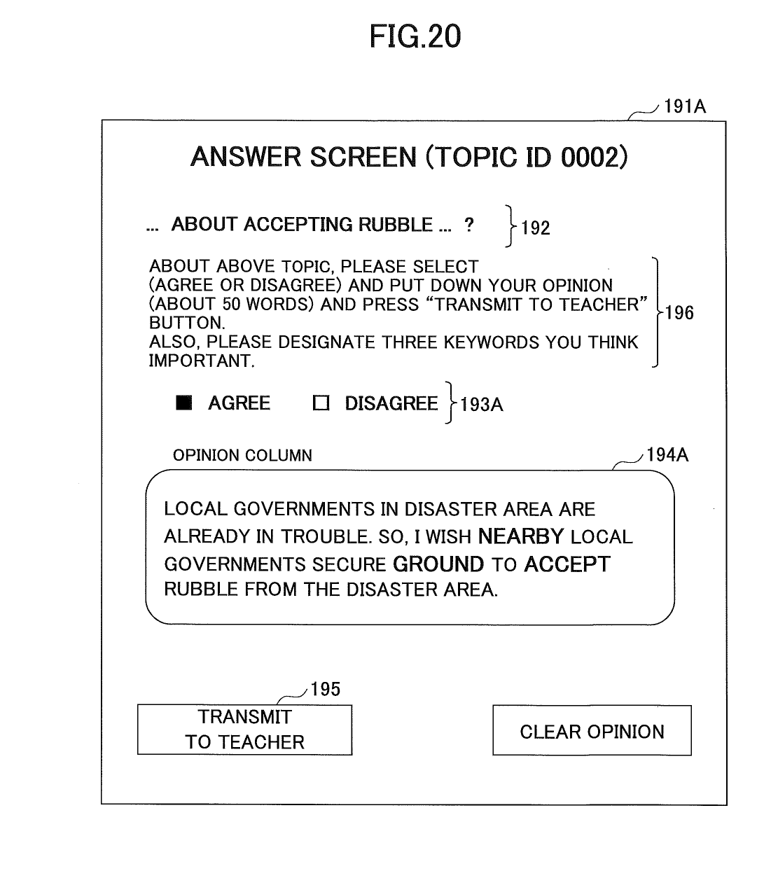

FIG. 20 illustrates another example of the question answer screen 191A which is displayed on the student terminals 300. The question answer screen 191A of FIG. 20 illustrates a state when the input of the opinion in the question answer screen 191 of FIG. 19 is finished.

In the example of the question answer screen 191A of FIG. 20, “pro (yes)” is selected in the selection column 193A, and keywords “nearby prefecture”, “ground”, and “acceptance” are designated in the input opinion in the opinion input column 194A.

In this embodiment, in the state where inputs are finished as illustrated in FIG. 20, when the opinion transmission button 195 is operated, the opinion information including the selection of agree or disagree, the opinion, and three keywords is transmitted from the student terminal 300 to the teacher terminal 200. The teacher terminal 200 stores the opinion information in the opinion database 230 in association with the student ID identified by the IP address of the student terminal 300 which transmits the opinion information.

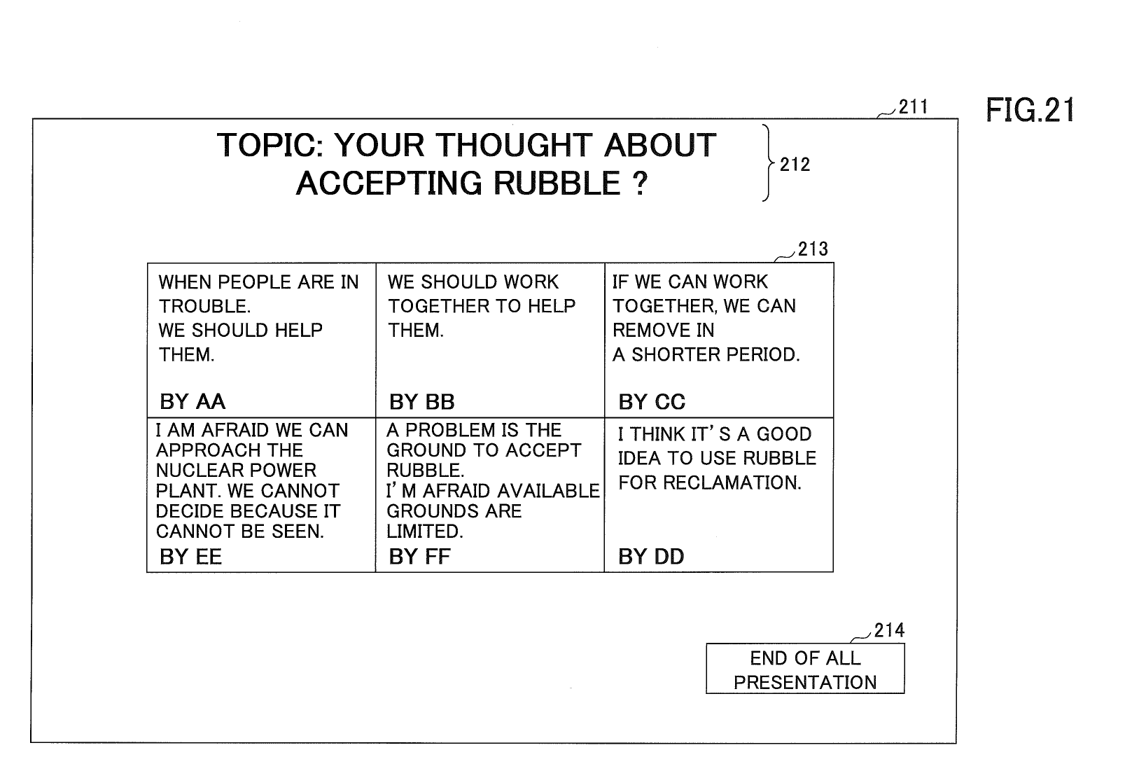

FIG. 21 illustrates an example of a matrix display screen 211 which is displayed on the electronic whiteboard 400. For example, the matrix display screen 211 of FIG. 21 is displayed on the electronic whiteboard 400 in step S1404 of FIG. 14.

In the matrix display screen 211 of FIG. 21, a topic content 212 and a list 213 of the students' opinions received by the teacher terminal 200 are displayed. In the matrix display screen 211 in this embodiment, areas displaying the respective names and the opinions of the students are displayed in a matrix manner.

Further, in the matrix display screen 211 in this embodiment, an end button 214 may further be displayed to terminate the display of the matrix display screen 211. Further, in this embodiment, when the display part of the electronic whiteboard 400 has an operational function such as that of a touch panel, the display of the electronic whiteboard 400 may be terminated when the end button 214 is operated.

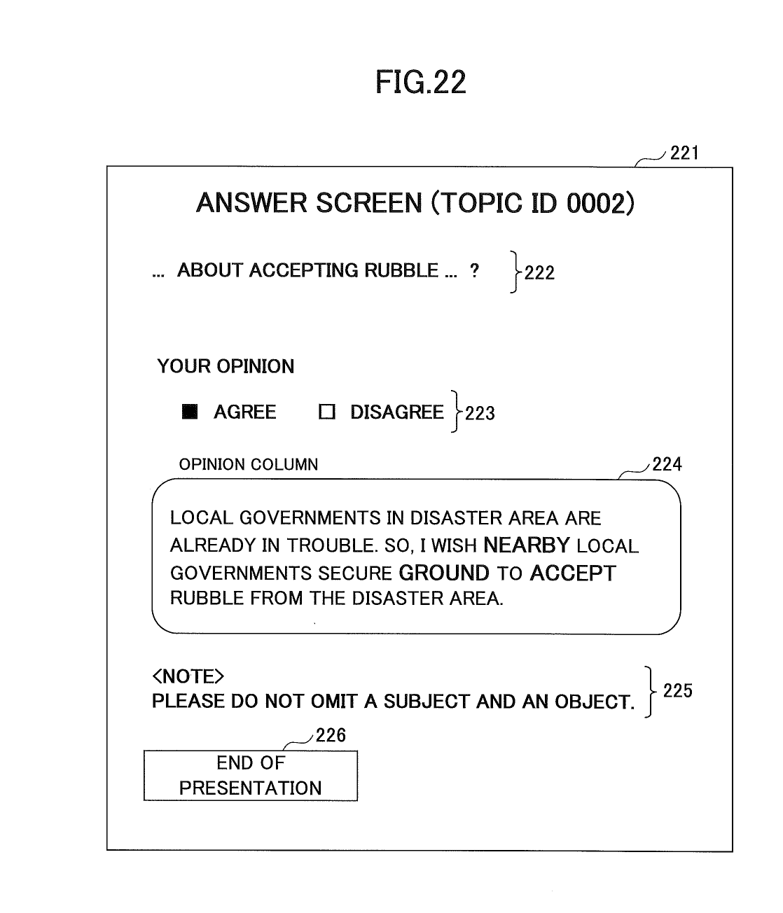

FIG. 22 illustrates an example of a speaker screen 221 which is displayed on the student terminal 300 of the speaker. For example, the speaker screen 221 of FIG. 22 is displayed on the student terminal 300 of the speaker in step S1406 of FIG. 14.

In the speaker screen 221 in this embodiment, a topic content 222, a selection column 223 where the opinion information, which is input by the speaker, is reflected, and an opinion input column 224 are displayed. More specifically, the speaker screen 221 in this embodiment displays the topic content 222, the selection column 223 indicating agree or disagree, which is selected by the speaker, is reflected, and the opinion input column 224 where the opinion input by the speaker and the keywords designated by the speaker are reflected. In the speaker screen 221, a message 225 which is selected from the speaker message database 270 and a presentation end button 226 to indicate the end of the presentation are further displayed.

In FIG. 22, a case is displayed where the speaker is the student whose student ID is “1001” (see, for example, FIG. 6). Therefore, the message selector 298 refers to the student level table 282 and acquires the speaker level “1” of the student whose student ID is “1001”, and selects the message corresponding to the speaker level “1” from the speaker message database 270.

The message to be selected in this case is “please do not omit a subject and a predicate”. Therefore, this message 225 is displayed in the speaker screen 221.

In this embodiment, a message in accordance with the level of the student as the speaker can be displayed on the speaker screen, so that it is possible to support the presentation of the student as the speaker.

Further, the question generator 296 of the teacher terminal 200 generates a question sentence which is based on the opinion of the student having the student ID “1001”, that is, based on the content of the opinion which is reflected in the opinion input column 224 of FIG. 22.

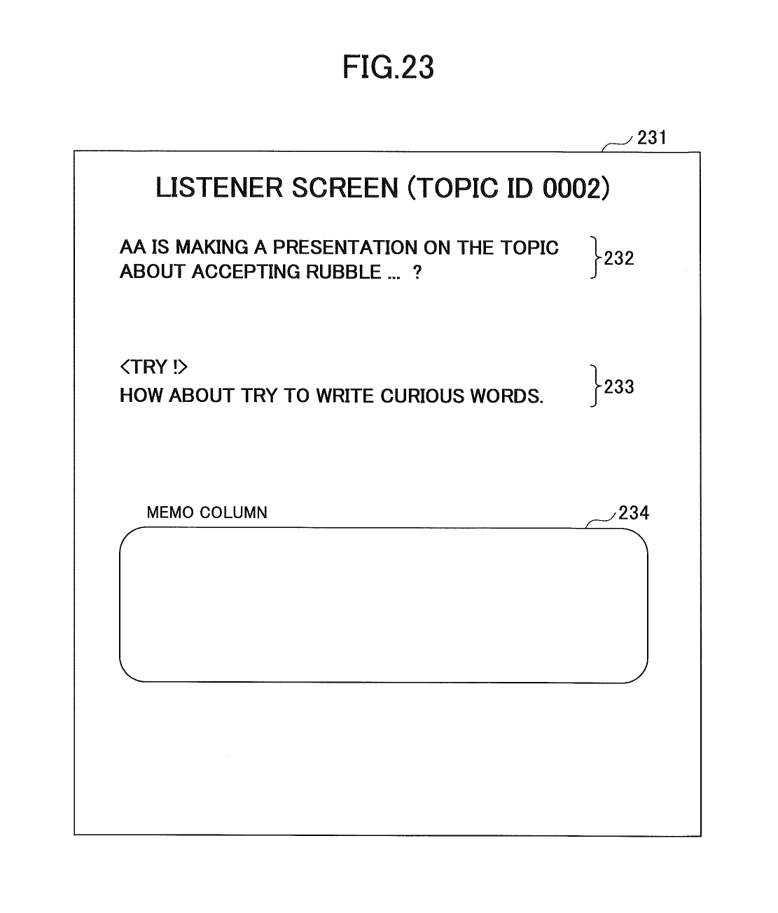

FIG. 23 illustrates an example of a listener screen 231 which is displayed on the student terminal 300 of the listener. The listener screen 231 of FIG. 23 is displayed on the student terminal 300 of the listener in step S1407 of FIG. 14. Further, the listener screen 231 of FIG. 23 is the screen which is displayed on the student terminal 300 of the student whose student ID is “1004”.

In the listener screen 231 in this embodiment, a sentence 232 including the topic content and the name of the student as the speaker, a message 233 indicating the suggestions when the listeners hear the presentation, and a memo input column 234 are displayed.

In FIG. 23, the listener is the student whose student ID is “1004”. Therefore, the message selector 298 of the teacher terminal 200 refers to the student level table 282 and acquires the listener level “2” corresponding to the student ID “1004”. Then, the message selector 298 selects the message corresponding to the listener level “2” from the listener message database 260. The message selected here is “put down curious words”. Therefore, this message 233 is displayed in the listener screen 231.

In this embodiment, by displaying a message which corresponds to the level of the student as the listener in the listener screen 231, it becomes possible to support the hearing of the presentation by the student as the listener.

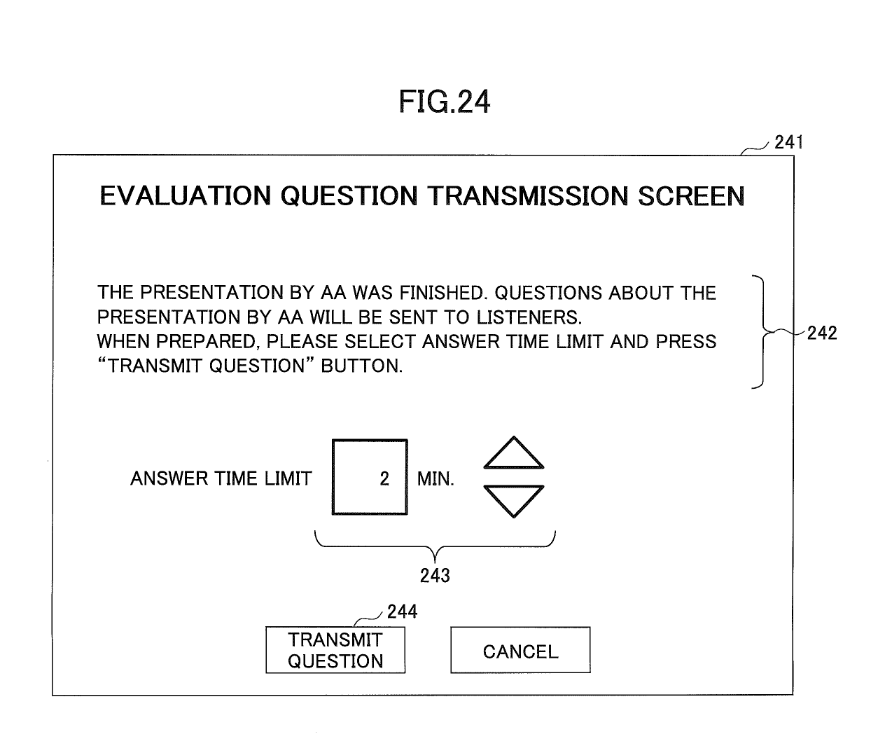

FIG. 24 illustrates an example of a transmission screen 241 displayed on the teacher terminal 200 to transmit the evaluation questions. For example, the transmission screen 241 of FIG. 24 is displayed on the teacher terminal 200 in step S1601 of FIG. 16.

In the transmission screen 241 in this embodiment, a message 242 indicating that the presentation by the student as the presenter is finished and prompting the setting of the listener answer time limit, the setting column 243 to set the listener answer time limit, and a question transmission button 244 to request to transmit the questions are displayed.

When the listener answer time limit is set in the setting column 243 and the question transmission button 244 is operated in the transmission screen 241, the teacher terminal 200 transmits the screen data of the question answer screen, which includes the question sentences generated by the question generator 296, to the student terminal 300 of the listener.

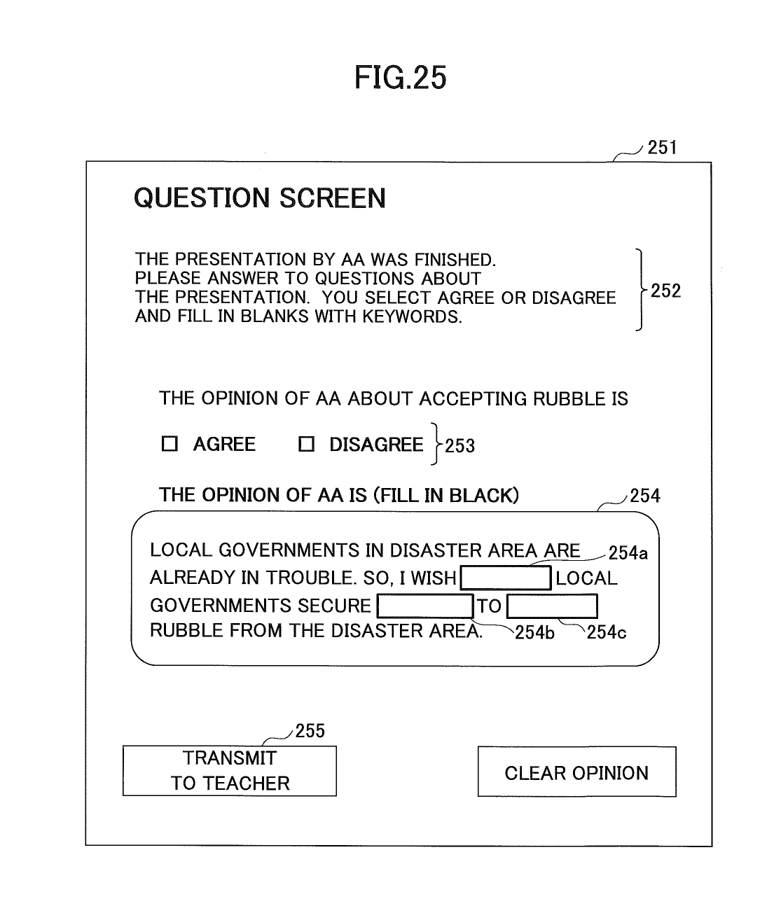

FIG. 25 illustrates a first example of a question answer screen 251 which is displayed on the student terminal 300 of the listener. For example, the question answer screen 251 of FIG. 25 is displayed on the student terminal 300 of the listener in step S1605 of FIG. 16.

In the question answer screen 251 in this embodiment, sentences 252 which indicate that the presentation by the speaker is finished and prompts the listener to answer the questions about the presentation by the speaker, an agree or disagree selection column 253, an opinion display column 254, and an answer transmission button 255 are displayed.

The agree or disagree selection column 253 in the question answer screen 251 is used by the listener to select whether the speaker agrees or disagrees with the topic. In the opinion display column 254, the opinion data of the speaker is displayed in which the keywords designated by the speaker are deleted (changed to blank).

The question answer screen 251 of FIG. 25 is in a case where the speaker is the student whose student ID is “1001”. Therefore, in the opinion display column 254, the question sentence based on the opinion data corresponding to the student ID “1001” acquired from the opinion database 230 are displayed in a manner such that the blanks 254a, 254b, and 254c are formed at the positions where the keywords “nearby prefecture”, “ground”, and “acceptance” are originally described.

When the answer “agree” or “disagree” is selected in the agree or disagree selection column 253, keywords are input in the blanks 254a, 254b, and 254c of the opinion display column 254, and the answer transmission button 255 is operated, the student terminal 300 transmits the selection result whether to agree or disagree and input keywords to the teacher terminal 200 as answer information.

Upon receiving the answer information, the teacher terminal 200 causes the database updater 294 to store the answer information in the question-answer database 240.

Further, in FIG. 25, an example of the question answer screen 251 is described which is displayed on the student terminal 300 of the listener after the presentation by the speaker ends. Note that, however, the present invention is not limited to this configuration. For example, the question answer screen 251 may be displayed on the student terminal 300 of the listener when the speaker starts the presentation.

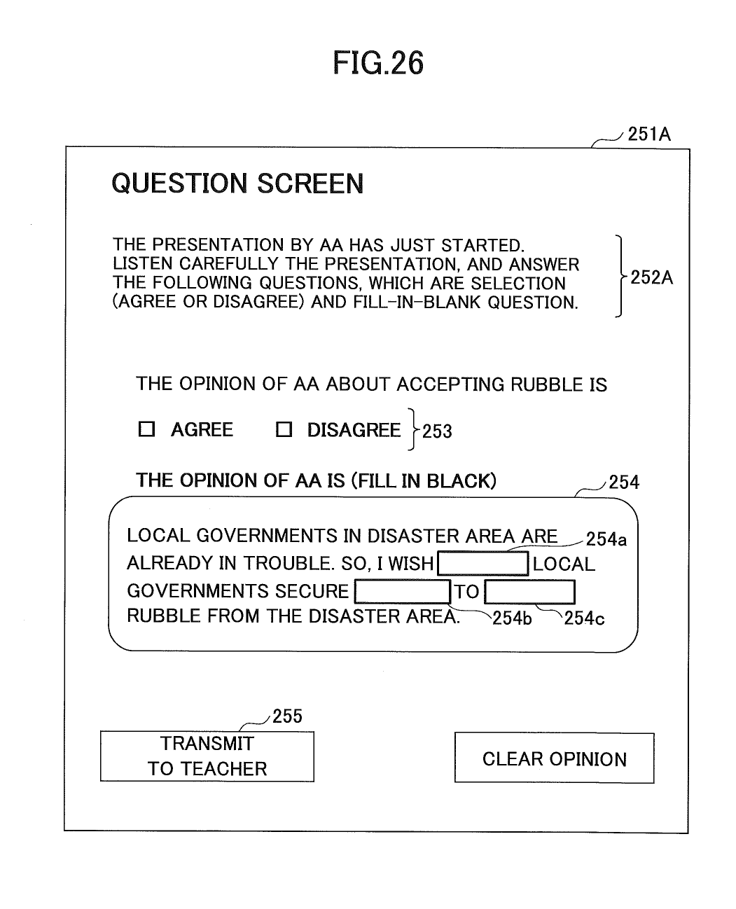

FIG. 26 illustrates a second example of a question answer screen 251A which is displayed on the student terminal 300 of the listener. For example, the question answer screen 251A of FIG. 26 is displayed on the student terminal 300 when the speaker starts his/her presentation. Specifically, for example, when recording of the content of the presentation by the speaker is started (see step S1408 of FIG. 14), the teacher terminal 200 may generate the screen data of the question answer screen 251A and transmit the screen data to the student terminal 300 of the listener, so as to display the question answer screen 251A on the student terminal 300.

The question answer screen 251A is similar to the question answer screen 251 except that the sentences 252A are displayed that indicates that the presentation by the speaker is started and prompts the listener to carefully hear the presentation and answer the questions. Therefore, the repeated descriptions thereof are herein omitted.

In the question answer screens 251 and 251A described with reference to FIGS. 25 and 26, the input of the keywords, which are answers of the question, in the blanks 254a, 254b, and 254c is prompted. Note that, however, the present invention is not limited to this configuration. For example, correct keywords, which are the answers of the question, may be selected from among keyword choices.

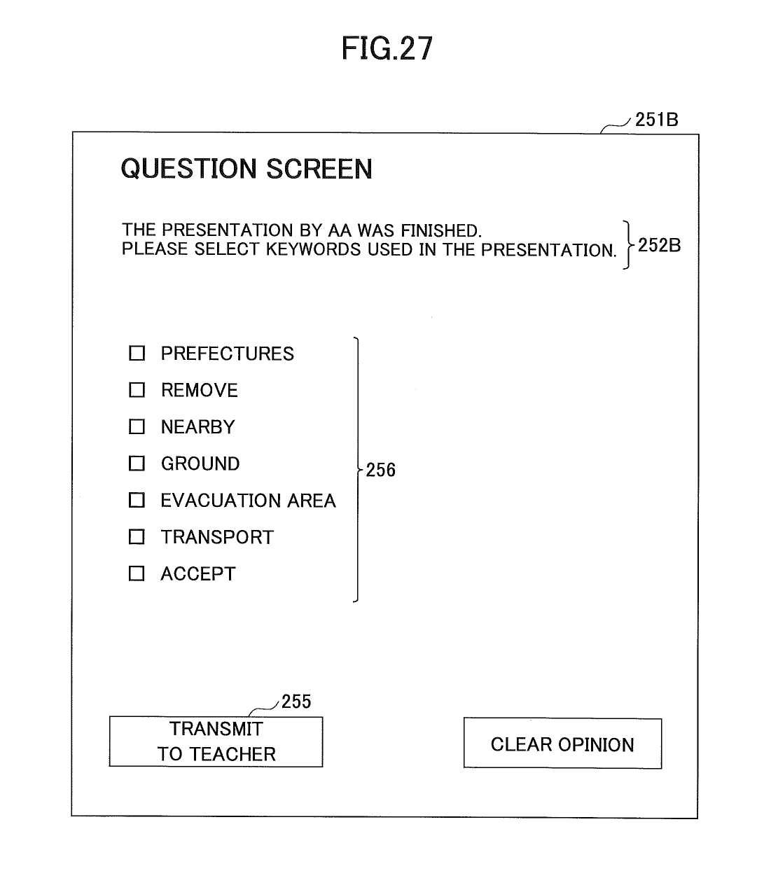

FIG. 27 illustrates a third example of a question answer screen 251B which is displayed on the student terminal 300 of the listener. The question answer screen 251B of FIG. 27 is a screen to select the correct keywords, which are the answers of the question, from some choices.

In the question answer screen 251B, a sentences 252B indicating that the presentation by the speaker is finished and prompting the selection of the keywords which are used in the speaker's presentation, keyword choices 256, and the answer transmission button 255 are displayed. Further, in the question answer screen 251B of FIG. 27, the agree or disagree selection column is not displayed. However, the agree or disagree selection column 253 similar to that in FIGS. 25 and 26 may be displayed in the question answer screen 251B.

Further, the sentences 252B indicate that the presentation by the speaker is finished. However, alternatively, for example, the sentences 252B may indicate that the presentation by the speaker is started. In this case, the question answer screen 251B is displayed on the student terminal 300 of the listener when the recording of the presentation content is started.

When the keywords as the answers of the question are selected from among the keyword choices 256, and the answer transmission button 255 is operated in the question answer screen 251B, the selected keywords are transmitted to the teacher terminal 200 as the answers.

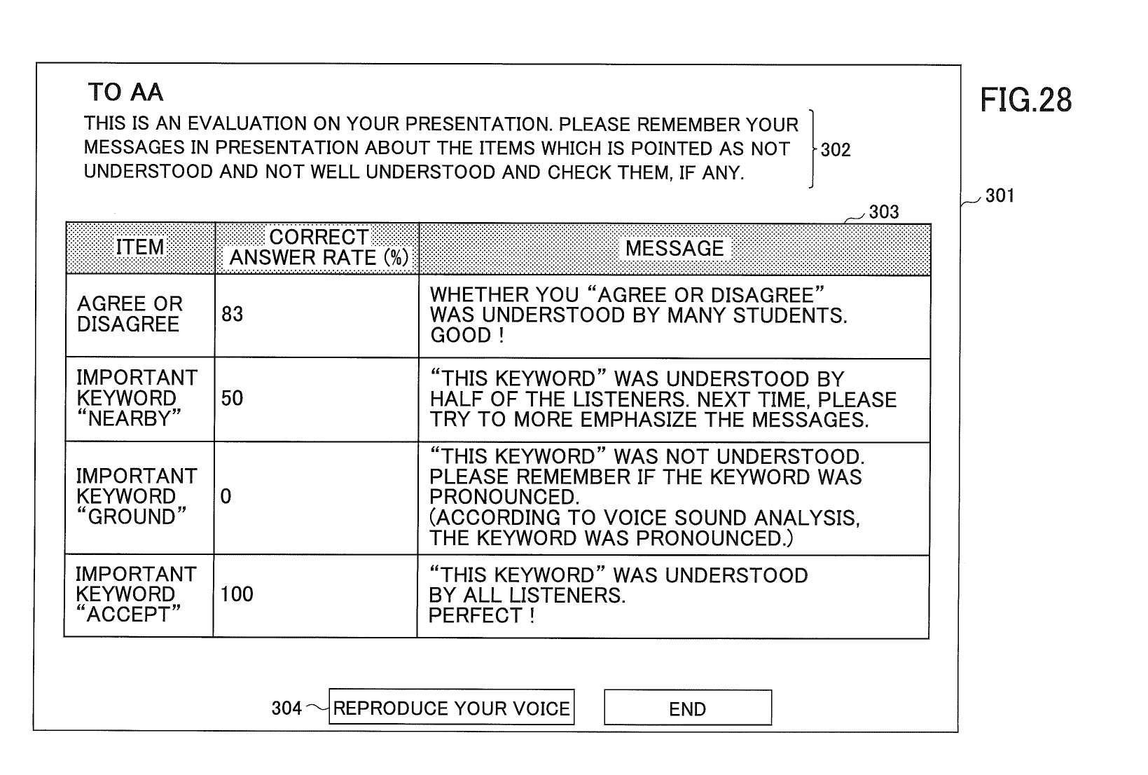

FIG. 28 illustrates a first example of a speaker evaluation screen 301 which is displayed on the student terminal 300 of the speaker. The speaker evaluation screen 301 of FIG. 28 is displayed on the student terminal 300 of the speaker when the corresponding screen data are transmitted to the student terminal 300 of the speaker in step S1704 of FIG. 17.

In the speaker evaluation screen 301 in this embodiment, sentences 302 suggesting the review of the evaluation on the student as the speaker, an evaluation result 303, and a reproduction instruction button 304 to reproduce the voice sound file of the presentation content are displayed.

In the following, the evaluation result 303 of the speaker in this embodiment is described. In this embodiment, the answers to the questions are collected from the student terminals 300 of the listeners, so that the correct answer rates of the selection (agree or disagree) and the designated keywords which are calculated on an item basis and the messages corresponding to the correct answer rates in the items are displayed.

In FIG. 28, the speaker is the student whose student ID is “1001”. Therefore, the correct answer rates are calculated by assuming that the correct answers are based on the selected result of the selection (agree or disagree) and the designated keywords included in the opinion information corresponding to the student ID “1001”.

Here, the evaluation on the speaker is described specifically with reference to FIG. 7. In the example of FIG. 7, a rate of the students who provide the correct answer (the correct answer rate) among the student of the same group ID about the selection (agree or disagree) of the speaker is 83%.

Similarly, the correct answer rates of the designated three keyword are 50% for the first keyword “nearby prefecture”, 0% for the second keyword “ground”, and 100% for the third keyword “acceptance”.

In this embodiment, the messages corresponding to the correct answer rates of the items are displayed. For example, the correct answer rate of the selection (agree or disagree) is 83%. In this case, the message corresponding to this correct answer rate in the message database 250 (see FIG. 8) is “understood by many people (GOOD)”. Therefore, this message is displayed in the evaluation result 303 as the message corresponding to the correct answer rate of the selection (agree or disagree).

Regarding other items, the corresponding messages based on the message database 250 are displayed in the evaluation result 303 in the same manner as described above.

Further, when the reproduction instruction button 304 is operated, the voice sound file is reproduced which corresponds to the student ID in the opinion database 230. Therefore, for example, it is possible for the speaker to hear the voice sound of the presentation of the speaker to determine whether the keyword corresponding to a low correct answer rate in the evaluation result 303 was pronounced during the presentation.

Further, in this embodiment, by displaying the speaker evaluation screen 301 on the student terminal 300 of the student of the speaker, it becomes possible for the student as the speaker to understand how much of the presentation content by the speaker can be understood by the listeners, and it becomes possible to prompt the student as the speaker to consider which point should be changed to improve, for example, the ability to speak/communication.

In the above description, a result of the reproduction of the voice sound file is not displayed. However, in this embodiment, when the reproduction of the voice sound file is instructed, the reproduction result of the voice sound file may be displayed in the speaker evaluation screen. An example in this case is described below.

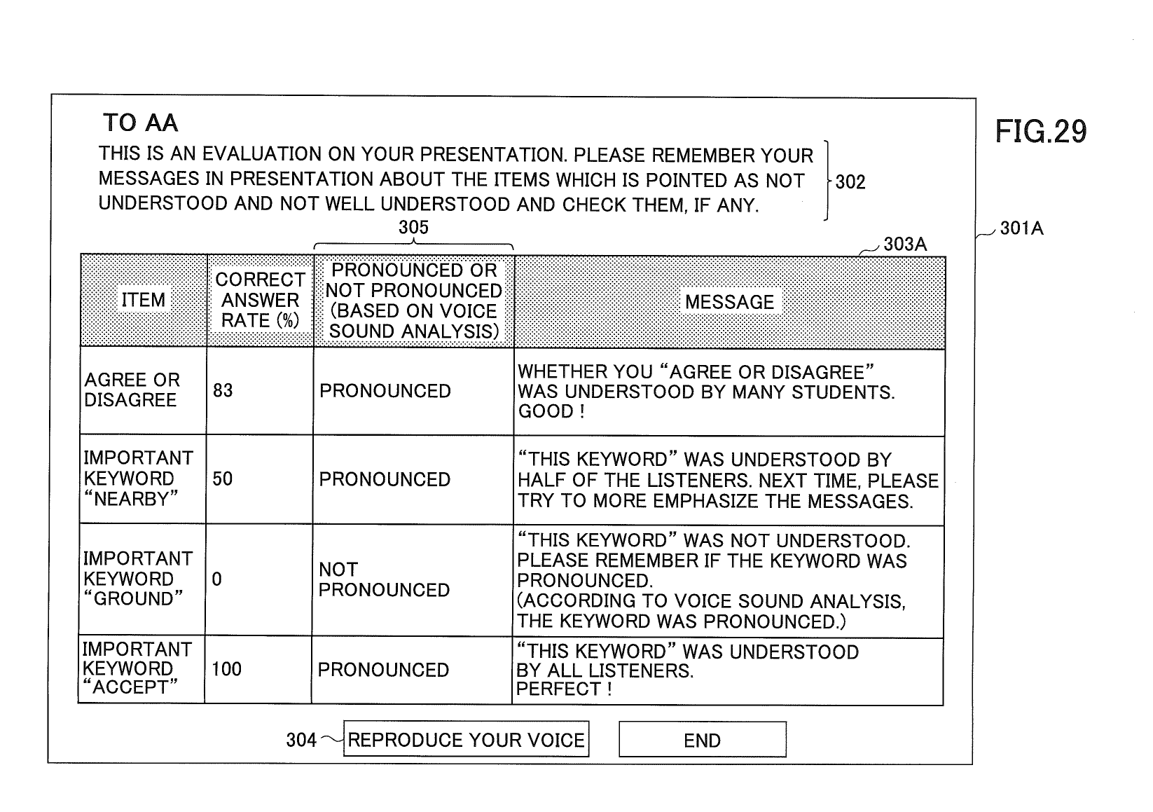

FIG. 29 illustrates a second example of a speaker evaluation screen 301A which is displayed on the student terminal 300 of the speaker. The speaker evaluation screen 301A of FIG. 29 includes a result of the instruction to reproduce the voice sound file.

When receiving the instruction to reproduce the voice sound file, the teacher terminal 200 in this embodiment causes the voice sound controller 288 to reproduce the voice sound file, and determines whether the keywords designated in the opinion data are included in the content of the presentation. Further, in this embodiment, when receiving the instruction to reproduce the voice sound file, the teacher terminal 200 may transmit the voice sound file stored in the opinion database 230 to the student terminal 300 of the speaker, so as to reproduce the voice sound file by the student terminal 300.

Further, the teacher terminal 200 generates the screen data of the speaker evaluation screen 301A including an analysis result 305 and transmits the generated screen data to the student terminal 300 of the speaker.

In the speaker evaluation screen 301A of FIG. 29, as the analysis result 305, comments whether the designated keywords are presented (pronounced) in the presentation are described. As illustrated in FIG. 29, it is described that the keywords (items) corresponding to higher correct answer rates are pronounced and the keyword “ground” corresponding to the correct answer rate “0%” is not pronounced in the presentation.

Further, in the example of FIG. 29, in the message corresponding to the item which was not pronounced, the message “not pronounced” is also displayed.

In this embodiment, by recording the content of the presentation and performing voice analysis as described above, it becomes possible for the student as the speaker to determine whether all the designated keywords were pronounced.

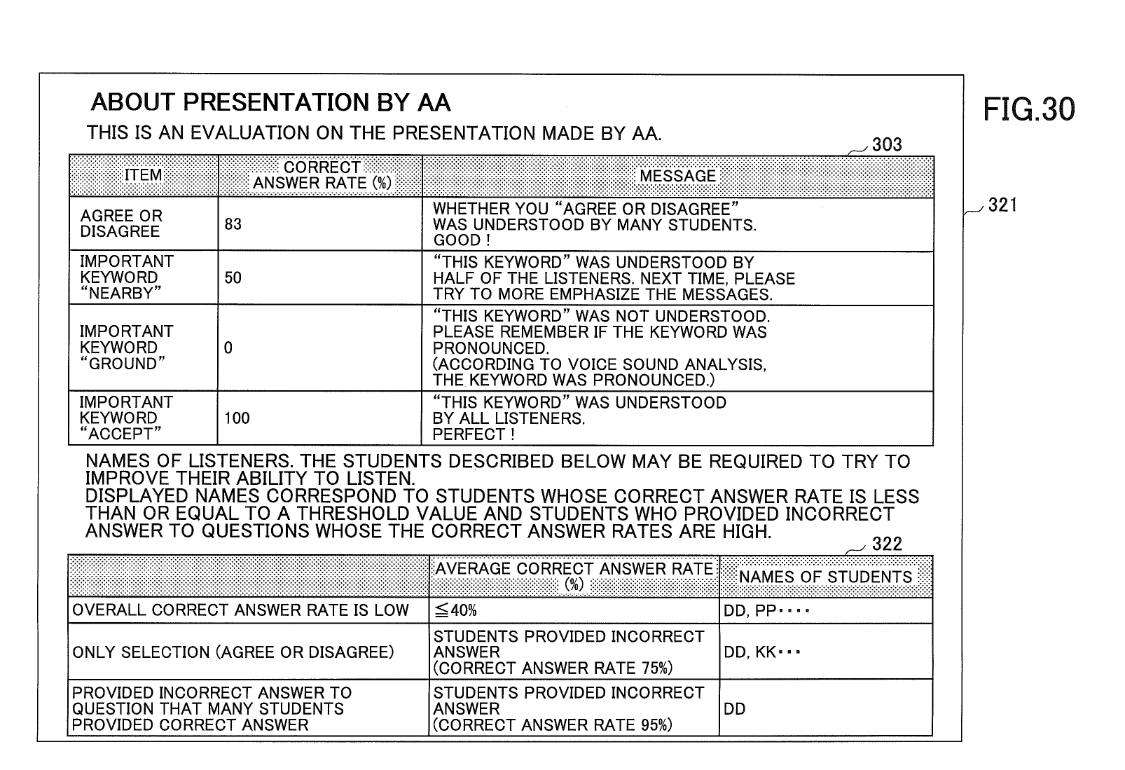

FIG. 30 illustrates an example of a teacher evaluation screen 321 which is displayed on the teacher terminal 200. For example, the teacher evaluation screen 321 of FIG. 30 is displayed on the teacher terminal 200 in step S1708 of FIG. 17.

In the teacher evaluation screen 321 of FIG. 30, an evaluation result 303 of the student as the speaker and an evaluation result 322 of the students as the listeners. The evaluation result 303 is already described with reference to FIG. 28. In the evaluation result 322 of the students as the listeners, for example, especially, the names of the students are displayed whose ability to listen is desired to be improved.

In this embodiment, as the evaluation result 322 of the students as the listeners, three kinds of evaluation results can be displayed. One evaluation result displays the names of the students whose average correct answer rates are less than or equal to a threshold value which is used to determine that a value of the average correct answer rate of all the answer items is low when the value is less than or equal to the threshold value. Another evaluation result displays the names of the students who provided a wrong answer in the selection (agree or disagree). The other evaluation result displays the names of the students who provided a wrong answer to a question of the item whose correct answer rate is high.

In this embodiment, by displaying the above evaluation results as the evaluations of the students as the listeners, especially, it becomes possible to display the names of the students whose ability to listen is desired to be improved to the teacher.

Further, in this embodiment, a case is described where three kinds of evaluation results can be displayed as the evaluation result of the students as the listeners. Note that, however, the present invention is not limited to this configuration. For example, the names of the students whose correct answer rates are less than a predetermined value may be displayed. Further, the names of the students having higher correct answer rates may also be displayed. Further, kinds of the evaluation may be set by the teacher.

As described above, according to this embodiment, by displaying the evaluation result of the student as the speaker and the evaluation result of the students as the listeners on the teacher terminal 200, it becomes possible to support the evaluation of the “ability to speak/communicate” and the “ability to listen” of each of the students by the teacher.

Further, in this embodiment, a listener evaluation screen including the correct answer rates on a student basis, the correct answer rates on an item basis, etc., may be displayed on the student terminals 300 of the listeners. By displaying the listener evaluation screen on the student terminals 300 of the listeners, it becomes possible for a student as the listener to know how much of the presentation content can be understood by the student as the listener. Further, in the listener evaluation screen, both the correct answer rate of the student as the listener and the correct answer rate of all students as the listeners may also be displayed. By doing this, it becomes possible for the student as the listener to know his/her own ability to listen.

### Second Embodiment

In the following, a second embodiment is described with reference to a drawing. The second embodiment differs from the first embodiment in that an evaluation support server 120 is provided in which the evaluation support program 290 is installed in the evaluation support system 100A. Therefore, in the following description of the second embodiment, only the configuration different from the first embodiment is described and the same and a similar reference numerals are used to describe the same or a similar elements and repeated descriptions thereof are herein omitted.

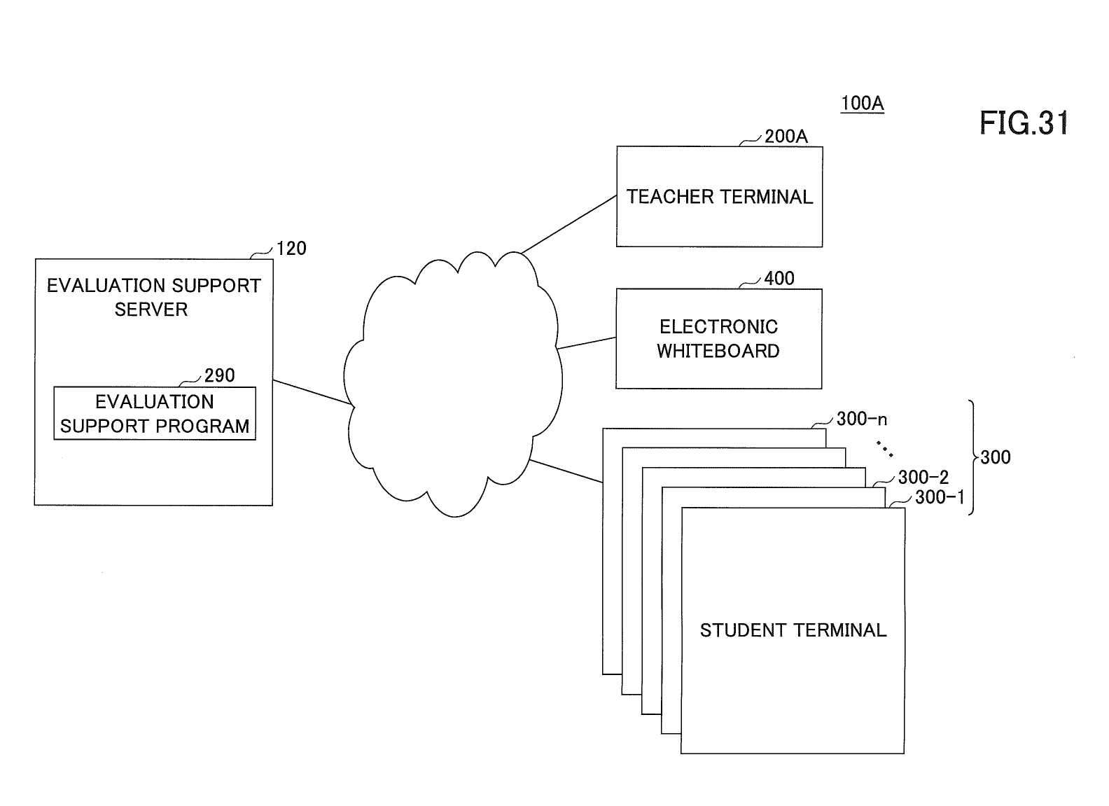

FIG. 31 illustrates an example configuration of an evaluation support system according to the second embodiment. The evaluation support system 100A includes the evaluation support server 120, a teacher terminal 200A, the student terminals 300, and the electronic whiteboard 400. In the evaluation support server 120 in this embodiment, the evaluation support program 290 is installed. Further, in the evaluation support server 120 in this embodiment, the databases and the tables stored in the teacher terminal 200 in the first embodiment are stored.

In the evaluation support system 100A in this embodiment, the processes, which are performed by the teacher terminal 200 in the first embodiment, are performed by the evaluation support server 120, and the evaluation support server 120 transmits the screen data of the various screens described above to the teacher terminal 200A, the student terminals 300, and the electronic whiteboard 400. Therefore, the teacher terminal 200A simply displays the screens based on the screen data transmitted from the evaluation support server 120.

Further, in the embodiment, a case is described where the evaluation support server 120 stores the databases and the tables stored in the teacher terminal 200 in the first embodiment. Note that, however, the present invention is not limited to this configuration. For example, the databases and the tables in this embodiment may be stored in a storage device which is connected to the evaluation support server 120.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiments of the present inventions have been described in detail, it is to be understood that various changes, substitutions, and alterations could be made hereto without departing from the spirit and scope of the invention.

1. A non-transitory computer-readable recording medium storing a program for causing a computer to execute a process comprising:
generating screen data for answering questions about opinion information related to a topic which is input from a first student terminal;
transmitting the screen data to second student terminals;
collecting answers to the questions input from the second student terminals; and
calculating correct answer rates of the answers to the questions.

2. The recording medium according to claim 1, the process further comprising:
generating screen data of an evaluation screen to display an evaluation result on a student, who uses the first student terminal, based on the correct answer rates and an evaluation result on students, who use the second student terminals, based on the correct answer rates; and
outputting the screen data.

3. The recording medium according to claim 1, the process further comprising:
generating screen data of a presenter evaluation screen to display an evaluation result on a student who uses the first student terminal; and
transmitting the screen data of the presenter evaluation screen to the first student terminal.

4. The recording medium according to claim 1, the process further comprising:
generating screen data of a listener evaluation screen to display an evaluation result on students who use the second student terminals; and
transmitting the screen data of the listener evaluation screen to the second student terminals.

5. The recording medium according to claim 2,
wherein the answers to the questions include values of plural items, and
wherein, in the calculating, correct answers of the plural items are acquired from the opinion information, the correct answers are compared with respective values of the plural items included in the answers to the questions, and correct answer rates of the answers on a question basis and correct answer rates on an item basis are calculated.

6. The recording medium according to claim 5,
wherein the evaluation result on the student who uses the first student terminal includes a message corresponding to the correct answer rates of the answers on the question basis and the correct answer rates on the item basis.

7. The recording medium according to claim 5,
wherein the evaluation result on the students who use the second student terminals includes names of students whose correct answer rates of the answers to the questions are less than a first threshold value and names of students who provided an incorrect answer for an item whose correct error rate is higher than a second threshold value.

8. The recording medium according to claim 5,
wherein the plural items include an item requesting to select agree or disagree to the topic which is input from the first student terminal and an item requesting to input a keyword which is designated from the first student terminal, and
wherein the evaluation result on the students who use the second student terminals includes names of the students who provided incorrect answer for the item requesting to select agree or disagree to the topic.

9. The recording medium according to claim 1,
wherein the first student terminal is used by a student who is selected as a presenter to provide a presentation of an opinion about the topic, and
wherein the second student terminals are used by students who listen to the presentation of the opinion about the topic.

10. The recording medium according to claim 9, the process further comprising:
acquiring a voice sound file in which the presentation by the presenter is recorded;
analyzing whether a designated keyword is pronounced in the voice sound file; and
including a result of the analyzing in an evaluation result on the student who is selected as the presenter.

11. An evaluation support method executed by a computer, the method comprising:
generating screen data for answering questions about opinion information related to a topic which is input from a first student terminal;
transmitting the screen data to second student terminals;
collecting answers to the questions input from the second student terminals; and
calculating correct answer rates of the answers to the questions.

12. An evaluation support apparatus comprising:
a transmitter configured to generate screen data for answering questions about opinion information related to a topic which is input from a first student terminal, and transmit the screen data to second student terminals; and
a correct answer rate calculator configured to collect answers to the questions input from the second student terminals, and calculate correct answer rates of the answers to the questions.
